(19) United States
(12) Patent Application Publication
(10) Pub. No.: US 2012/0192737 A1
(43) Pub. Date: Aug. 2, 2012

(54) RESIN COMPOSITION FOR LASER ENGRAVING, RELIEF PRINTING PLATE PRECURSOR FOR LASER ENGRAVING, AND RELIEF PRINTING PLATE AND PROCESS FOR MAKING THE SAME

(75) Inventor: Shigefumi KANCHIKU, Haibara-gun (JP)

(73) Assignee: FUJIFILM CORPORATION, Tokyo (JP)

(21) Appl. No.: 13/359,296

(22) Filed: Jan. 26, 2012

(30) Foreign Application Priority Data
Jan. 28, 2011 (JP) 2011-016862

(51) Int. Cl. B41N 1/06; C08G 64/42; C08G 63/91; C08L 83/08; C08L 69/00; B29C 35/08; C08K 3/36; C08K 7/00; C09D 183/08; C09D 169/00; C09D 167/00; C08F 2/46; C08G 77/388; C08L 67/00

(52) U.S. Cl. 101/379; 528/26; 524/588; 524/493; 427/493; 264/400

(57) ABSTRACT

Disclosed are a resin composition for laser engraving including a resin having two groups having specific structures and having a number average molecular weight of 5,000 or more and 500,000 or less, a relief printing plate precursor for laser engraving comprising a relief-forming layer formed from the resin composition on a support, a process for making the relief printing plate precursor, a process of making a relief printing plate using the relief printing plate precursor, and a relief printing plate having a relief layer which is manufactured by the process.

### TECHNICAL FIELD

The present invention relates to a resin composition for laser engraving, relief printing plate precursor for laser engraving, and a relief printing plate and a process for making the same.

### BACKGROUND ART

A large number of so-called “direct engraving CTP methods”, in which a relief-forming layer is directly engraved by means of a laser are proposed. In the method, a laser light is directly irradiated to a flexographic printing plate precursor to cause thermal decomposition and volatilization by photothermal conversion, thereby forming a concave part. Differing from a relief formation using an original image film, the direct engraving CTP method can control freely relief shapes. Consequently, when such image as an outline character is to be formed, it is also possible to engrave that region deeper than other regions, or, in the case of a fine halftone dot image, it is possible, taking into consideration resistance to printing pressure, to engrave while adding a shoulder. With regard to the laser for use in the method, a high-power carbon dioxide laser is generally used. In the case of the carbon dioxide laser, all organic compounds can absorb the irradiation energy and convert it into heat. On the other hand, inexpensive and small-sized semiconductor lasers have been developed, wherein, since they emit visible lights and near infrared lights, it is necessary to absorb the laser light and convert it into heat.

As a relief printing plate precursor for laser engraving, those described in JP-A-2010-100048 (JP-A denotes a Japanese unexamined patent application publication), JP-A-2009-262370 or International Patent Application WO 2005/070691 are known.

### SUMMARY OF THE INVENTION

It is an object of the present invention to provide a resin composition for laser engraving from which a relief printing plate having excellent laser engraving sensitivity, rinsing properties, ink transferability, printing durability and peeling resistance can be obtained, a relief printing plate precursor using the resin composition for laser engraving, a process for making a relief printing plate using the relief printing plate precursor, and a relief printing plate obtained by the process.

The above problems of the present invention were solved by the means described in following <1>, <13>, <16> and <18>. Preferable embodiments <2> to <12>, <14>, <15>, <17> and <19> are also described below.

<1> A resin composition for laser engraving comprising (Component A) a resin having a group represented by Formula (I) and a group represented by Formula (II), and having a number average molecular weight of 5,000 or more and 500,000 or less:

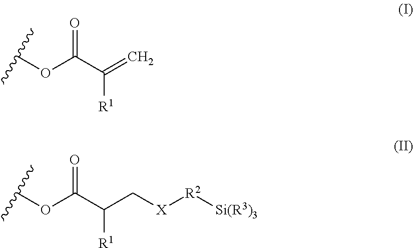

(In Formulae (I) and (II), X represents —S— or —N(R⁰)—; R⁰ represents a hydrogen atom or an alkyl group; R¹ represents a hydrogen atom or a methyl group; R² represents a divalent linking group; and R³s each independently represent an alkoxy group, a halogen atom, or an alkyl group having 1 to 30 carbon atoms. However, at least one of R³s represents an alkoxy group or a halogen atom),

<2> the resin composition for laser engraving according to <1>, wherein the ratio of the average numbers of functional groups of the group represented by Formula (I) and the group represented by Formula (II) ((I)/(II)) in Component A is 0.1 or more and 4 or less,

<3> the resin composition for laser engraving according to <1> or <2>, wherein the ratio of the average numbers of functional groups of the group represented by Formula (I) and the group represented by Formula (II) ((I)/(II)) in Component A is 0.3 or more and 1.5 or less,

<4> the resin composition for laser engraving according to any one of <1> to <3>, wherein the ratio of the average numbers of functional groups of the group represented by Formula (I) and the group represented by Formula (II) ((I)/(II)) in Component A is 0.4 or more and 1.0 or less,

<5> the resin composition for laser engraving according to any one of <1> to <4>, wherein Component A is at least one selected from the group consisting of a carbonate resin, a urethane resin, an acrylic resin and an ester resin,

<6> the resin composition for laser engraving according to any one of <1> to <5>, further comprising (Component B) silica particles,

<7> the resin composition for laser engraving according to <6>, wherein the number average particle size of Component B is 0.01 μm or more and 10 μm or less,

<8> the resin composition for laser engraving according to any one of <1> to <7>, further comprising (Component C) an alcohol exchange reaction catalyst,

<9> the resin composition for laser engraving according to any one of <1> to <8>, further comprising (Component D) a radical polymerization initiator,

<10> the resin composition for laser engraving according to any one of <1> to <9>, further comprising (Component E) a compound having a weight average molecular weight of less than 5,000 and having a polymerizable unsaturated group,

<11> the resin composition for laser engraving according to any one of <1> to <10>, further comprising (Component F) a compound having a weight average molecular weight of less than 5,000 and having a hydrolyzable silyl group and/or silanol group,

<12> the resin composition for laser engraving according to any one of <1> to <11>, further comprising (Component G) a photothermal conversion agent capable of absorbing light having a wavelength of 700 to 1,300 nm,

<13> a relief printing plate precursor for laser engraving, comprising a relief-forming layer formed from the resin composition for laser engraving according to any one of <1> to <12> on a support,

<14> the relief printing plate precursor for laser engraving according to <13>, wherein the relief-forming layer is crosslinked by light and/or heat,

<15> the relief printing plate precursor for laser engraving according to <13>, wherein the relief-forming layer is crosslinked by heat,

<16> a process for making a relief printing plate, comprising (1) a step of forming a layer of the resin composition for laser engraving from the resin composition for laser engraving according to any one of <1> to <12>; (2) a step of crosslinking the layer of the resin composition for laser engraving by light and/or heat to thus form a crosslinked relief-forming layer; and (3) a step of laser-engraving the crosslinked relief-forming layer to form a relief layer, in this order,

<17> the process for making a relief printing plate according to <16>, wherein Step (2) is a step of crosslinking the relief-forming layer by heat,

<18> a relief printing plate having a relief layer, produced by the process according to <16> or <17>,

<19> the relief printing plate according to <18>, wherein the thickness of the relief layer is 0.05 mm or more and 10 mm or less.

### DESCRIPTION OF EMBODIMENTS

The present invention is explained in detail below.

### (Resin Composition for Laser Engraving)

The resin composition for laser engraving of the present invention (hereinafter, also simply called “resin composition”) comprises a resin having a group represented by following Formula (I) and a group represented by following Formula (II), and having a number average molecular weight of 5,000 or more and 500.000 or less.

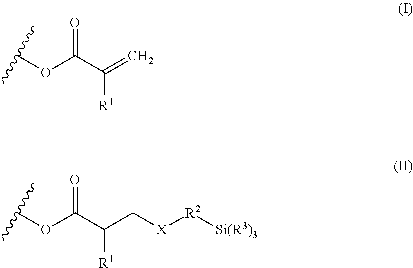

(In Formulae (I) and (II), X represents —S— or —N(R⁰)—; R⁰ represents a hydrogen atom or an alkyl group; R¹ represents a hydrogen atom or a methyl group; R² represents a divalent linking group; and R³s each independently represent an alkoxy group, a halogen atom, or an alkyl group having 1 to 30 carbon atoms. However, at least one of R³s represents an alkoxy group or a halogen atom).

In the present invention, the notation ‘lower limit to upper limit’ expressing a numerical range means ‘at least the lower limit but no greater than the upper limit’, and the notation ‘upper limit to lower limit’ means ‘no greater than the upper limit but at least the lower limit’. That is, they are numerical ranges that include the upper limit and the lower limit.

In the present invention ‘(meth)acryl group’ means ‘acryl group’ and/or ‘methacryl group’. This also applies to a case of ‘(meth)acrylate’ ‘(meth)acrylamide’ or ‘(meth)acrylic acid’.

Further, ‘(Component B) silica particles’ etc. are simply called ‘Component B’ etc.

The resin composition for laser engraving of the present invention may widely be applied to other applications without particular limitations, in addition to the application of the relief-forming layer of a relief printing plate precursor to be subjected to laser engraving (also called ‘relief printing plate precursor’ or ‘printing plate precursor’). For example, it may be applied not only to the relief-forming layer of a printing plate precursor that is subjected to raised relief formation by laser engraving, which will be described in detail below, but also to the formation of other products in which asperities or openings are formed on the surface, for example, various printing plates and various formed bodies in which images are formed by laser engraving such as an intaglio plate, a stencil plate and a stamp.

Among them, a preferred embodiment is use in formation of a relief-forming layer provided above an appropriate support.

In regard to the resin composition of the present invention, the operating mechanism that is speculated for the use of Component A will be described below.

When the group represented by Formula (I) (an acrylate group or a methacrylate group) is present in Component A, both the crosslinking based on a polymerizable unsaturated double bond and the crosslinking with the hydrolyzable silanol group present in the group represented by Formula (II) are formed, and a high crosslinking density can be obtained. As a result, it is considered that the film properties are improved, peeling resistance is improved, and rinsing properties are also improved.

Furthermore, as will be described later, a group represented by Formula (I) and a group represented by Formula (II) can be introduced to Component A after polymerization, and even in the case of using a monomer having a hydroxyl group at the time of polymerization, such as polyurethane or polyester, or in the case of copolymerizing with a monomer having an acidic or basic functional group, a group represented by Formula (I) and a group represented by Formula (II) can be easily introduced.

Constituent components of the resin composition for laser engraving are explained below.

### (Component A) Resin Having Group Represented by Formula (I) and Group Represented by Formula (II), and Having Number Average Molecular Weight of 5,000 or More and 500,000 or Less

The resin composition for laser engraving of the present invention comprises (Component A) a resin having a group represented by Formula (I) and a group represented by Formula (II), and having a number average molecular weight of 5,000 or more and 500,000 or less (binder polymer).

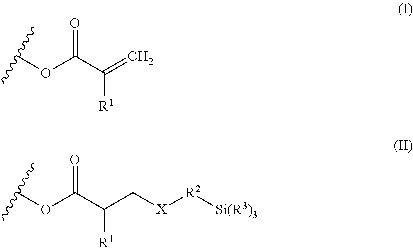

(In Formulae (I) and (II), X represents —S— or —N(R⁰)—; R⁰ represents a hydrogen atom or an alkyl group; R¹ represents a hydrogen atom or a methyl group; R² represents a divalent linking group; and R³s each independently represent an alkoxy group, a halogen atom, or an alkyl group having 1 to 30 carbon atoms. However, at least one of R³s represents an alkoxy group or a halogen atom).

In Formula (I) and Formula (II), R¹ represents a hydrogen atom or a methyl group, and is more preferably a hydrogen atom.

In Formula (II), X represents —S— or —N(R⁰)—, and R⁰ represents a hydrogen atom or an alkyl group. The alkyl group represented by R⁰ is preferably an alkyl group having 1 to 8 carbon atoms, more preferably an alkyl group having 1 to 4 carbon atoms, even more preferably an alkyl group having 1 to 3 carbon atoms, and particularly preferably a methyl group or an ethyl group. R⁰ is preferably a hydrogen atom, a methyl group or an ethyl group, more preferably a hydrogen atom or a methyl group, and even more preferably a hydrogen atom.

X is preferably —S— or —NH—, and most preferably —S—.

In Formula (II), R² represents a divalent linking group. R² is preferably a divalent hydrocarbon group, or a divalent group combining a hydrocarbon group and an ether bond (—O—) or an amino bond (—NR⁰—, wherein R⁰ means the same as R⁰ in Formula (II), and preferred ranges are also the same), and more preferably a divalent hydrocarbon group, a poly(alkyleneoxy) group, or a poly(alkyleneoxy)alkylene group. Furthermore, the total number of carbon atoms of the divalent linking group is preferably 1 to 60, and more preferably 1 to 40. R² is particularly preferably an alkylene group having 1 to 8 carbon atoms, and most preferably an alkylene group having 1 to 3 carbon atoms.

In Formula (II), three R³s are present, and R³s each independently represent an alkoxy group, a halogen atom, or an alkyl group having 1 to 30 carbon atoms. However, at least one of R³s represents an alkoxy group or a halogen atom.

When R³ is an alkoxy group, R³ is preferably an alkoxy group having 1 to 15 carbon atoms, more preferably an alkoxy group having 1 to 8 carbon atoms, even more preferably an alkoxy group having 1 to 4 carbon atoms, and particularly preferably an ethoxy group or a methoxy group.

When R³ is a halogen atom, examples of the halogen atom include an F atom, a Cl atom, a Br atom, and an I atom, but R³ is preferably a Cl atom or a Br atom, and more preferably a Cl atom.

When R³ is an alkyl group, R³ is an alkyl group having 1 to 30 carbon atoms, preferably an alkyl group having 1 to 12 carbon atoms, more preferably an alkyl group having 1 to 8 carbon atoms, and even more preferably an alkyl group having 1 to 3 carbon atoms.

Among R³s, at least one is an alkoxy group or a halogen atom, preferably two of R³s are alkoxy groups or halogen atoms, more preferably three of R³s are alkoxy groups or halogen atoms, and most preferably three of R³s are alkoxy groups. That is, —Si(R³)₃ is particularly preferably a trialkoxysilyl group.

The number average molecular weight of Component A is 5,000 or more and 500,000 or less. If the number average molecular weight is less than 5,000, the strength of the relief printing plate precursor and the relief printing plate is decreased, and therefore, durability against repeated use is deteriorated. Furthermore, if the number average molecular weight is greater than 500,000, when a relief-forming layer is formed from a resin composition for laser engraving, the viscosity increases excessively, and it becomes difficult to produce a relief printing plate precursor and a relief printing plate.

The number average molecular weight is preferably 5,000 or more and 300,000 or less, more preferably 15,000 or more and 200,000 or less, and even more preferably 30,000 or more and 100,000 or less.

Meanwhile, the number average molecular weight according to the present invention is a value measured using gel permeation chromatography (GPC) and calculated by calibrating with polystyrenes with known molecular weights.

Examples of Component A include a polystyrene resin, a polyester resin, a polyamide resin, a polyurea resin, a polyamideimide resin, a polyurethane resin, a polysulfone resin, a polyether sulfone resin, a polyimide resin, a polycarbonate resin, a hydrophilic polymer containing a hydroxyethylene unit, an acrylic resin, an acetal resin, an epoxy resin, a polycarbonate resin, a rubber, and a thermoplastic elastomer. Among these, from the viewpoint of the solvent resistance to an ink cleaning agent containing an ester solvent or an ink cleaning agent containing a hydrocarbon solvent, which are used in printing, Component A is preferably at least one resin selected from the group consisting of a carbonate resin, a urethane resin, an acrylic resin and an ester resin.

Meanwhile, a carbonate resin is a resin having a carbonate bond, a urethane resin is a resin having a urethane bond, an acrylic resin is a resin having a monomer unit derived from (meth)acrylic acid or an ester thereof, and an ester resin is a resin having an ester bond.

The method for producing Component A is not particularly limited, and any known method can be used. For example, a method in which a compound which has a carbonate bond and/or an ester bond, has plural reactive groups such as a hydroxyl group, an amino group, an epoxy group, a carboxyl group, an acid anhydride group, a ketonic carbonyl group (>C=O), a hydrazine residue, an isocyanato group, an isothiocyanato group, a cyclic carbonate residue, and an alkoxycarbonyl group, and has a molecular weight of about several thousands, is reacted with a compound having plural functional groups that are capable of bonding with the reactive groups (for example, a polyisocyanate having a hydroxyl group, an amino group or the like); an adjustment of the molecular weight and conversion of the molecular end to a bonding group are carried out; subsequently, an organic compound having a functional group that is capable of reacting with this terminal bonding group and a group represented by Formula (I) (a (meth)acryloyloxy group) is reacted with the reaction product to thus introduce a group represented by Formula (I) to the ends; subsequently, some of the introduced (meth)acryloyloxy groups are subjected to Michael addition of a mercaptan or an amine; and the mercaptan or amine is converted to a group represented by Formula (II), and the like can be used.

According to the present invention, it is preferable for Component A, as explained above, that a group represented by Formula (I) (a (meth)acryloyloxy group) is introduced into the ends of a polymer, and then the group represented by Formula (I) is converted to a group represented by formula (II) by subjecting some of the groups represented by Formula (I) to an addition reaction. As such, when a silanol group contained in the group represented by Formula (II) is introduced in two stages, it is possible to easily introduce a silanol group even to a resin having a hydroxyl group at the time of polymerization, or to a resin having a monomer unit having an acidic or basic functional group. Furthermore, when some of the groups represented by Formula (I) are allowed to remain, crosslinking based on a polymerizable unsaturated bond can be introduced into the relief printing plate precursor.

The ratio of the average numbers of functional groups of the group represented by Formula (I) and the group represented by Formula (II) ((I)/(II)) in Component A is preferably 0.1 or more and 4 or less. When the ratio is in the range described above, a printing plate having excellent printing durability and peeling resistance can be obtained by introducing crosslinking based on an unsaturated double bond and a silanol group.

The ratio of the average numbers of functional groups ((I)/(II)) is more preferably 0.3 or more and 1.5 or less, and even more preferably 0.4 or more and 1.0 or less.

The ratio of the average numbers of functional groups can be adjusted by controlling the amount of the compound that is used in the addition reaction with the group represented by Formula (I).

The ratio of the average numbers of functional groups is measured by NMR. That is, the average number of the polymerizable unsaturated group based on the group represented by Formula (I) before the conversion to the group represented by Formula (II), and the average number of the polymerizable unsaturated group based on the group represented by Formula (I) after the conversion to the group represented by Formula (II) are respectively measured. The conversion ratio is given by the following formula.

Conversion ratio={1−(Average number of polymerizable unsaturated group after conversion/average number of polymerizable unsaturated group before conversion)}×100

Furthermore, the ratio of the average numbers of functional groups ((I)/(II)) is given by the following formula.

Ration of average numbers of functional groups ((I)/(II))=Average number of polymerizable unsaturated groups after conversion/(average number of polymerizable unsaturated groups before conversion−average number of polymerizable unsaturated groups after conversion)

According to the present invention, examples of the mercaptan used to convert a group represented by Formula (I) to a group represented by Formula (II) include 3-mercaptopropylmethyldimethoxysilane (KBM-802, manufactured by Shin-Etsu Chemical Co., Ltd.), 3-mercaptopropyltrimethoxysilane (KBM-803, manufactured by Shin-Etsu Chemical Co., Ltd.), and 3-mercaptopropyltriethoxysilane (KBE-803, manufactured by Shin-Etsu Chemical Co., Ltd.).

Furthermore, according to the present invention, examples of the amine used to convert a group represented by Formula (I) to a group represented by Formula (II) include 3-aminopropyltrimethoxysilane (KBM-903, Shin-Etsu Chemical Co., Ltd.), 3-aminopropyltriethoxysilane (KBE-903, Shin-Etsu Chemical Co., Ltd.), N-2-(aminoethyl)-3-aminopropylmethyldimethoxysilane (KBM-602, Shin-Etsu Chemical Co., Ltd.), N-2-(aminoethyl)-3-aminopropyltrimethoxysilane (KBM-603, Shin-Etsu Chemical Co., Ltd.), and N-2-(aminoethyl)-3-aminopropyltriethoxysilane (KBE-603, Shin-Etsu Chemical Co., Ltd.).

Examples of the compound having a carbonate bond that is used in the production of Component A include aliphatic polycarbonate diols such as 4,6-polyalkylene carbonate diol, 8,9-polyalkylene carbonate diol, and 5,6-polyalkylene carbonate diol. Furthermore, aliphatic polycarbonate diols having an aromatic ring in the molecule may also be used.

When a terminal hydroxyl group of these compounds is condensation reacted with a diisocyanate compound such as tolylene diisocyanate, diphenylmethane diisocyanate, hexamethylene diisocyanate, isophorone diisocyanate, dicyclohexylmethane diisocyanate, tetramethylxylene diisocyanate, xylene diisocyanate, naphthalene diisocyanate, trimethylhexamethylene diisocyanate, p-phenylene diisocyanate, cyclohexylene diisocyanate, lysine diisocyanate, or triphenylmethane diisocyanate; or a triisocyanate compound such as triphenylmethane triisocyanate, 1-methylbenzene-2,4,6-triisocyanate, naphthalene-1,3,7-triisocyanate, or biphenyl-2,4,4′-triisocyanate, a urethane bond can be introduced, and also, the compound can be made to have a high molecular weight. Furthermore, the terminal hydroxyl group or isocyanato group can also be used to introduce a group represented by Formula (I).

Examples of the compound having an ester bond that is used in the production of Component A include polyesters obtained by condensation reacting a dicarboxylic acid compound such as adipic acid, phthalic acid, malonic acid, succinic acid, itaconic acid, oxalic acid, glutaric acid, pimelic acid, suberic acid, azelaic acid, sebacic acid, fumaric acid, isophthalic acid, or terephthalic acid, and a compound having two or more hydroxyl groups in the molecule, such as ethylene glycol, diethylene glycol, polyethylene glycol, propylene glycol, polypropylene glycol, trimethylene glycol, 1,4-butanediol, 1,5-pentanediol, 1,6-hexanediol, 1,7-heptanediol, 1,8-octanediol, 1,9-nonanediol, 1,10-decanediol, pinacol, cyclopentanediol, or cyclohexanediol; and polyesters such as polycaprolactone. When a terminal hydroxyl group or carboxyl group of these compounds is condensation reacted with a diisocyanate compound, a urethane bond can be introduced, and also, the compound can be made to have a high molecular weight. Furthermore, the terminal hydroxyl group, carboxyl group or isocyanate group can also be used to introduce a group represented by Formula (I).

It is also preferable for Component A to have a siloxane bond.

A siloxane bond means a molecular structure in which silicon (Si) and oxygen (O) are alternately bonded.

It is preferable that the main chain and/or side chain in the resin having a siloxane bond contains a silicone compound represented by following Mean Composition Formula (1).

RₚQᵣXₛSiO_{(4-p-r-s)/2} (1)

In Formula (1), R represents one kind or two or more kinds of hydrocarbon groups selected from the group consisting of a linear or branched alkyl group having 1 to 30 carbon atoms, a cycloalkyl group having 5 to 20 carbon atoms, an alkyl group having 1 to 30 carbon atoms (carbon number before substitution) substituted with an alkoxy group or aryl group having 1 to 20 carbon atoms, an aryl group having 6 to 20 carbon atoms substituted with a halogen atom, an alkoxycarbonyl group having 2 to 30 carbon atoms, a monovalent group containing a carboxyl group or a salt thereof, a monovalent group containing a sulfo group or a salt thereof, and a polyoxyalkylene group;

Q and X each independently represent one kind or two or more kinds of hydrocarbon groups selected from the group consisting of a hydrogen atom, a linear or branched alkyl group having 1 to 30 carbon atoms, a cycloalkyl group having 5 to 20 carbon atoms, an alkyl group having 1 to 30 carbon atoms substituted with an alkoxy group or aryl group having 1 to 20 carbon atoms, an aryl group having 6 to 20 carbon atoms substituted with a halogen atom, an alkoxycarbonyl group having 2 to 30 carbon atoms, a monovalent group containing a carboxyl group or a salt thereof, a monovalent group containing a sulfo group or a salt thereof, and a polyoxyalkylene group; and p, r and s represent numbers satisfying the relations: 0<p<4, 0≦r<4, 0≦s<4, and (p+r+s)<4.

Examples of the compound having a siloxane bond that can be used for the production of a resin having a siloxane bond include silicone oils.

Examples of the silicone oils include organopolysiloxanes having from low viscosity to high viscosity, such as dimethylpolysiloxane, methylphenylpolysiloxane, methylhydrogenpolysiloxane, and dimethylsiloxane-methylphenylsiloxane copolymers; cyclic siloxanes such as octamethylcyclotetrasiloxane, decamethylcyclopentasiloxane, dodecamethylcyclohexasiloxane, tetramethyltetrahydrogencyclotetrasiloxane, and tetramethyltetraphenylcyclotetrasiloxane; silicone rubbers such as gum-like dimethylpolysiloxane having a high degree of polymerization, and gum-like dimethylsiloxane-methylphenylsiloxane copolymers; cyclic siloxane solutions the silicone rubber; trimethylsiloxysilicic acid; cyclic ciloxane solution of trimethylsiloxysilicic acid; higher alkoxy-modified silicones such as stearoxysilicone; and higher fatty acid-modified silicones.

Among these silicone oils, silicone oils having reactivity are preferable. Examples include monoamine-modified silicone oil, diamine-modified silicone oil, special amino-modified silicone oil, epoxy-modified silicone oil, alicyclic epoxy-modified silicone oil, carbinol-modified silicone oil, mercapto-modified silicone oil, carboxy-modified silicone oil, hydrogen-modified silicone oil, amino.polyether-modified silicone oil, epoxy.polyether-modified silicone oil, epoxy.aralkyl-modified silicone oil, reactive silicone oil, methacrylic-modified silicone oil, polyether-modified silicone oil, mercapto-modified silicone oil, phenol-modified silicone oil, silanol-modified silicon oil, fluorine-modified silicone oil, side chain amino-both end methoxy-modified silicone oil, and diol-modified silicone oil. When these silicone oils having reactivity are used, the introduction of a siloxane bond to the resin is facilitated.

If a siloxane bond is introduced into the main chain part of the resin, among the silicone oils having reactivity, both end-modified silicone oil is preferred. Examples include both end amino-modified silicone oil, both end epoxy-modified silicone oil, both end alicyclic epoxy-modified silicone oil, both end carbinol-modified silicone oil, both end methacrylic-modified silicone oil, both end polyether-modified silicone oil, both end mercapto-modified silicone oil, both end carboxy-modified silicone oil, both end phenol-modified silicone oil, and both end silanol-modified silicone oil.

When a siloxane bond is introduced into the side chain part of the resin, among the silicone oils having reactivity, single end modified silicone oils or side chain-modified silicone oils are preferred. Examples include single end diol-modified silicone oil, side chain monoamine-modified silicone oil, side chain diamine-modified silicone oil, side chain epoxy-modified silicone oil, side chain carbinol-modified silicone oil, side chain carboxy-modified silicone oil, side chain amino-polyether-modified silicone oil, side chain epoxy polyether-modified silicone oil, and side chain epoxyaralkyl-modified silicone oil.

Among the silicone oils having reactivity, from the viewpoints of reactivity, and handleability such as odor of irritability, both end carbinol-modified silicone oil or single end diol-modified silicone oil is preferred.

The viscosity of Component A at 20° C. is preferably 10 Pa·s or higher and 10 kPa·s or lower, more preferably 30 Pa·s or higher and 7 kPa·s or lower, and even more preferably 50 Pa·s or higher and 5 kPa·s or lower. When the viscosity is 10 Pa·s, the mechanical strength obtainable when the resin composition is produced into a printing plate precursor is satisfactory, and when the viscosity is 10 kPa·s or less, the resin composition can be easily deformed even at normal temperature, while mixing with other compositions or the formation of a printing plate precursor is facilitated.

The content of Component A in the resin composition for laser engraving of the present invention is not particularly limited, but the content is preferably 20 to 95 wt %, more preferably 30 to 90 wt %, and yet more preferably 40 to 85 wt %, relative to the total solids content.

The content of Component A in the relief-forming layer of the relief printing plate precursor for laser engraving of the present invention is preferably 20 to 95 wt %, more preferably 30 to 90 wt %, and yet more preferably 40 to 85 wt %.

### (Component B) Silica Particles

The resin composition for laser engraving of the present invention preferably comprises (Component B) silica particles.

According to the present invention, it is preferable for the silica particles that the number average particle size is 0.01 μm or more and 10 μm or less. When the number average particle size is in the range described above, tackiness can be reduced, the effect on the surface roughness of the printing plate precursor is small, and pattern formation by laser engraving is enabled without any defects occurring in printed images. Furthermore, it is preferable that the silica particles are porous fine particles or poreless ultrafine particles.

The number average particle size of Component B is preferably 0.01 μm to 10 μm, more preferably 0.5 μm to 8 μm, and even more preferably 1 μm to 5 μm.

Here, the number average particle size of the particles means an average value of the values of the major axis measured by microscopic observation. Specifically, the magnification is adjusted such that at least about 50 particles fit in the visual field of the microscope, and the major axes of the particles are measured. It is preferable to use a microscope having a measuring function, but the dimension may also be measured based on an image taken using a camera.

### <Porous Fine Particles>

The porous fine particles are defined as fine particles having fine pores which have a fine pore volume of 0.1 ml/g or greater, or fine particles having fine voids. As the resin composition includes porous fine particles, when the surface of the relief-forming layer is made to have a desired surface roughness, processing is facilitated. Examples of the processing include cutting, grinding, or polishing. The tackiness of the residue and the like occurring during the processing at the time of obtaining a desired surface roughness by the porous fine particles is reduced, and precision processing of the relief-forming layer surface is facilitated.

The porous fine particles are preferably such that the specific surface area is 10 m²/g or more and 1,500 m²/g or less, the average fine pore diameter is 1 nm or more and 1,000 nm or less, the fine pore volume is 0.1 ml/g or more and 10 ml/g or less, and the oil absorption is 10 ml/100 g or more and 2,000 ml/100 g or less. The specific surface area can be determined based on the BET equation from an adsorption isotherm of nitrogen at −196° C. Furthermore, in the measurement of the fine pore volume and the average fine pore diameter, a nitrogen adsorption method is used. The measurement of the oil absorption is carried out according to JIS-K5101. When the specific surface area of the porous fine particles is in the range described above, for example, in the case of forming image areas by engraving using a laser on a printing plate precursor, it is suitable for absorbing decomposition products that have been removed.

The number average particle size of the porous fine particles is preferably 0.01 μm or more and 10 μm or less. The number average particle size is more preferably 0.5 μm or more and 8 μm or less, and yet more preferably 1 μm or more and 5 μm or less. When the number average particle size is in the range described above, tackiness in the cutting, grinding and polishing processes can be reduced, the effect on the surface roughness of the printing plate precursor is small, and pattern formation by laser engraving is enabled without any defects occurring in printed images.

The shape of the porous fine particles is not particularly limited, and particles having a spherical shape, a flat shape or a needle shape, amorphous particles, or particles having protrusions on the surface can be used. Particularly, from the viewpoint of wear resistance, it is preferable that at least 70% of the particles are spherical particles having a true sphericity in the range of from 0.5 to 1.

As an index defining the degree of sphericity of the porous fine particles, the true sphericity is defined. The true sphericity according to the present embodiment is defined as the ratio of the maximum value D₁ of a circle which, when the image of a porous fine particle is projected, completely fits in the projected figure, and the minimum value D₂ of a circle in which the projected figure completely fits in (D₁/D₂). In the case of a true sphere, the true sphericity is 1.0. The true sphericity of the porous fine particle is preferably 0.5 or more and 1.0 or less, and more preferably 0.7 or more and 1.0 or less. When the true sphericity is 0.5 or greater, wear resistance as in a printing plate is satisfactory. A true sphericity of 1.0 is the upper limit of the true sphericity. As for the porous fine particles, preferably 70% or more, and more preferably 90% or more, of the porous fine particles have a true sphericity of 0.5 or greater. As a method for measuring the true sphericity, a method of making measurement based on a photograph taken using a scanning electron microscope can be used. In that case, it is preferable to take photographs at a magnification at which at least 100 or more particles fit in the monitor screen. Furthermore, although the values of D₁ and D₂ are measured based on a photograph, it is preferable to process the photograph using an apparatus which digitalizes photographs, such as a scanner, and then processing the data using an image analysis software.

Furthermore, it is also possible to use particles having cavities inside the particles, or spherical granules having a uniform fine pore diameter, such as silica sponge. Although not particularly limited, examples include porous silica, mesoporous silica, silica-zirconia porous gel, and porous glass. Furthermore, as in the case of layered clay compounds, since the fine pore diameter cannot be defined in materials in which voids having a size of several nanometers (nm) to several hundred nanometers (nm) are present between layers, according to the present invention, the interval of the voids present between the layers is defined as the fine pore diameter.

Furthermore, the surfaces of the porous fine particles are coated with a silane coupling agent, a titanate coupling agent or another organic compound to perform a surface modification treatment, and thus further hydrophilized or hydrophobized particles can also be used. One kind or two or more kinds of these porous fine particles can be selected.

### <Poreless Ultrafine Particles>

The poreless ultrafine particles according to the present embodiment are defined as particles having a fine pore volume of less than 0.1 ml/g. The number average particle size of the poreless ultrafine particles is the number average particle size directed to primary particles, and is preferably 10 nm or more and 500 nm or less, and more preferably least 10 nm or more and 100 nm or less. When the number average particle size is in this range, tackiness in the cutting, grinding and polishing processes can be reduced, the effect of the poreless ultrafine particles on the surface roughness of the relief printing plate precursor is small, and pattern formation by laser engraving is enabled without any defects occurring in the printed images.

The content of Component B in the resin composition for laser engraving of the present invention is not particularly limited, but the content is preferably in the range of 1 to 30 wt %, more preferably in the range of 3 to 20 wt %, and most preferably 5 to 15 wt %, relative to the total solids content.

When the content of Component B is in the range described above, the effect of Component B on the surface roughness of the printing plate precursor is small, and tackiness can be reduced without any defects occurring in the printed images, which is preferable.

### (Component C) Alcohol Exchange Reaction Catalyst

The resin composition for lazer engraving of the present invention preferably comprises (Component C) an alcohol exchange reaction catalyst.

The alcohol exchange reaction catalyst means a compound that accelerate the reaction between a hydrolyzable silyl group of Component A and a hydroxy group. Preferred examples of the alcohol exchange reaction catalyst includes an acidic catalyst or basic catalyst, and a metal complex catalyst.

The type of the alcohol exchange reaction catalyst is not limited, and examples of the alcohol exchange reaction catalyst include organic acids and inorganic acids, organic bases and inorganic bases, and salts thereof.

Examples of the organic or inorganic acids include halogenated hydrogen such as hydrochloric acid, nitric acid, sulfuric acid, sulfurous acid, hydrogen sulfide, perchloric acid, hydrogen peroxide, carbonic acid, carboxylic acids such as formic acid and acetic acid, substituted carboxylic acids in which R of a structural formula represented by RCOOH is substituted by another element or substituent, sulfonic acids such as benzenesulfonic acid, phosphoric acid, heteropoly acid, inorganic solid acid etc. Among these, methanesulfonic acid, p-toluenesulfonic acid, dodecylbenzenesulfonic acid, phosphoric acid, phosphonic acid and acetic acid are preferable, and, from the viewpoint of the film strength after the thermal crosslinking, methanesulfonic acid, p-toluenesulfonic acid and phosphoric acid are particularly preferable.

Examples of the organic bases and inorganic bases, and salts thereof include tertiary amines and imidazoles, inorganic bases, quaternary ammonium salts, and quaternary phosphonium salts.

Examples of the tertiary amines and imidazoles include trimethylamine, triethylamine, tripropylamine, tributylamine, tripentylamine, trihexylamine, dimethylethylamine, dimethylpropylamine, dimethylbutylamine, dimethylpentylamine, dimethylhexylamine, diethylpropylamine, diethylbutylamine, diethylpentylamine, diethylhexylamine, dipropylbutylamine, dipropylpentylamine, dipropylhexylamine, dibutylpentylamine, dibutylhexylamine, dipentylhexylamine, methyldiethylamine, methyldipropylamine, methyldibutylamine, methyldipentylamine, methyldihexylamine, ethyldipropylamine, ethyldibutylamine, ethyldipentylamine, ethyldihexylamine, propyldibutylamine, propyldipentylamine, propyldihexylamine, butyldipentylamine, butyldihexylamine, pentyldihexylamine, methylethylpropylamine, methylethylbutylamine, methylethylhexylamine, methylpropylbutylamine, methylpropylhexylamine, ethylpropylbutylamine, ethylbutylpentylamine, ethylbutylhexylamine, propylbutylpentylamine, propylbutylhexylamine, butylpentylhexylamine, trivinylamine, triallylamine, tributenylamine, tripentenylamine, trihexenylamine, dimethylvinylamine, dimethylallylamine, dimethylbutenylamine, dimethylpentenylamine, diethylvinylamine, diethylallylamine, diethylbutenylamine, diethylpentenylamine, diethylhexenylamine, dipropylvinylamine, dipropylallylamine, dipropylbutenylamine, methyldivinylamine, methyldiallylamine, methyldibutenylamine, ethyldivinylamine, ethyldiallylamine, tricyclopentylamine, tricyclohexylamine, tricyclooctylamine, tricyclopentenylamine, tricyclohexenylamine, tricyclopentadienylamine, tricyclohexadienylamine, dimethylcyclopentylamine, diethylcyclopentylamine, dipropylcyclopentylamine, dibutylcyclopentylamine, dimethylcyclohexylamine, diethylcyclohexylamine, dipropylcyclohexylamine, dimethylcyclopentenylamine, diethylcyclopentenylamine, dipropylcyclopentenylamine, dimethylcyclohexenylamine, diethylcyclohexenylamine, dipropylcyclohexenylamine, methyldicyclopentylamine, ethyldicyclopentylamine, propylcyclopentylamine, methyldicyclohexylamine, ethyldicyclohexylamine, propylcyclohexylamine, methyldicyclopentenylamine, ethyldicyclopentenylamine, propyldicyclopentenylamine, N,N-dimethylaniline, N,N-dimethylbenzylamine, N,N-dimethyltoluidines, N,N-dimethylnaphthylamines, N,N-diethylaniline, N,N-diethylbenzylamine, N,N-diethyltoluidine, N,N-diethylnaphthylamine, N,N-dipropylaniline, N,N-dipropylbenzylamine, N,N-dipropyltoluidine, N,N-dipropylnaphthylamine, N,N-divinylaniline, N,N-diallylaniline, N,N-divinyltoluidine, diphenylmethylamine, diphenylethylamine, diphenylpropylamine, dibenzylmethylamine, dibenzylethylamine, dibenzylcyclohexylamine, dibenzylvinylamine, dibenzylallylamine, ditolylmethylamine, ditolylethylamine, ditolylcyclohexylamine, ditolylvinylamine, triphenylamine, tribenzylamine, tri(tolyl)amine, trinaphthylamine, N,N,N′,N′-tetramethylethylenediamine, N,N,N′,N′-tetraethylethylenediamine, N,N,N′,N′-tetramethyltolylenediamine, N,N,N′,N′-tetraethyltolylenediamine, N-methylpyrrole, N-methylpyrrolidine, 2-ethyl-4-methylimidazole, 2-phenylimidazole, 1-(2-cyanoethyl)-2-ethyl-4-methylimidazole, 2-phenylimidazoline, N,N′-dimethylpiperazine, N-methylpiperidine, N-ethylpyrrole, N-methylpyrrolidine, N-ethylimidazole, N,N′-diethylpiperazine, N-ethylpiperidine, pyridine, pyridazine, pyrazine, quinoline, quinazoline, quinuclidine, N-methylpyrrolidone, N-methylmorpholine, N-ethylpyrrolidone, N-ethylmorpholine, N,N-dimethylanisole, N,N-diethylanisole, N,N-dimethylglycine, N,N-diethylglycine, N,N-dimethylalanine, N,N-diethylalanine, N,N-dimethylethanolamine, N,N-dimethylaminothiophene, 1,1,3,3-tetramethylguanidine, 1,8-diazabicyclo[5.4.0]undeca-7-ene, 1,5-diazabicyclo[4.3.0]nona-5-ene, 1,4-diazabicyclo[2.2.2]octane and hexamethylenetetramine etc. From the viewpoint of the film strength after the thermal crosslinking, 2-ethyl-4-methylimidazole, 2-phenylimidazole, 1-(2-cyanoethyl)-2-ethyl-4-methylimidazole, 2-phenylimidazoline, 1,8-diazabicyclo[5.4.0]undeca-7-ene, 1,5-diazabicyclo[4.3.0]nona-5-ene and 1,1,3,3-tetramethylguanidine are preferable, and 2-ethyl-4-methylimidazole, 2-phenylimidazole, 1,8-diazabicyclo[5.4.0]undeca-7-ene and 1,5-diazabicyclo[4.3.0]nona-5-ene are particularly preferable.

Examples of the inorganic bases include alkali metal hydroxides, alkali metal alkoxides and alkaline earth metal oxides. Among these, sodium t-butoxide, potassium t-butoxide, sodium methoxide, potassium methoxide, sodium ethoxide and potassium ethoxide are preferable, sodium t-butoxide, potassium t-butoxide, sodium ethoxide and potassium ethoxide are more preferable.

Examples of the quaternary ammonium salts include tetramethylammonium bromide, tetraethylammonium bromide, tetrabutylammonium bromide, tetramethylammonium bromide, benzyltrimethylammonium chloride, benzyltrimethylammonium bromide, decyltrimethylammonium chloride and decyltrimethylammonium bromide, etc. Among these, tetramethylammonium bromide, tetraethylammonium bromide and tetrabutylammonium bromide are preferable, and tetraethylammonium bromide is more preferable.

Examples of the quaternary phosphonium salts include tetramethylphosphonium bromide, tetraethylphosphonium bromide, tetrabutylphosphonium bromide, tetramethylphosphonium bromide, benzyltrimethylphosphonium chloride, benzyltrimethylphosphonium bromide, decyltrimethylphosphonium chloride and decyltrimethylphosphonium bromide. Among these, tetramethylphosphonium bromide, tetraethylphosphonium bromide and tetrabutylphosphonium bromide are preferable, and tetraethylphosphonium bromide is more preferable.

In regard to the basic compounds and acidic compounds, it is preferable to use a basic compound because the reaction proceeds smoothly.

### <Metal Complex Catalyst>

The metal complex catalyst that can be used as an alcohol exchange reaction catalyst in the present invention is preferably constituted from a metal element selected from Groups 2, 4, 5, and 13 of the periodic table and an oxo or hydroxy oxygen compound selected from β-diketones, ketoesters, hydroxycarboxylic acids and esters thereof, amino alcohols, and enolic active hydrogen compounds.

Furthermore, among the constituent metal elements, a Group 2 element such as Mg, Ca, Sr, or Ba, a Group 4 element such as Ti or Zr, a Group 5 element such as V, Nb, or Ta, and a Group 13 element such as Al or Ga are preferable, and they form a complex having an excellent catalytic effect. Among them, a complex obtained from Zr, Al, or Ti (ethyl orthotitanate, etc.) is excellent and preferable.

In the present invention, examples of the oxo or hydroxy oxygen-containing compound constituting a ligand of the above-mentioned metal complex include (3-diketones such as acetylacetone (2,4-pentanedione) and 2,4-heptanedione, ketoesters such as methyl acetoacetate, ethyl acetoacetate, and butyl acetoacetate, hydroxycarboxylic acids and esters thereof such as lactic acid, methyl lactate, salicylic acid, ethyl salicylate, phenyl salicylate, malic acid, tartaric acid, and methyl tartarate, ketoalcohols such as 4-hydroxy-4-methyl-2-pentanone, 4-hydroxy-2-pentanone, 4-hydroxy-4-methyl-2-pentanone, and 4-hydroxy-2-heptanone, amino alcohols such as monoethanolamine, N,N-dimethylethanolamine, N-methylmonoethanolamine, diethanolamine, and triethanolamine, enolic active compounds such as methylolmelamine, methylolurea, methylolacrylamide, and diethyl malonate ester, and compounds having a substituent on the methyl group, methylene group, or carbonyl carbon of acetylacetone.

A preferred ligand is an acetylacetone derivative, and the acetylacetone derivative in the present invention means a compound having a substituent on the methyl group, methylene group, or carbonyl carbon of acetylacetone. The substituent with which the methyl group of acetylacetone is substituted is a straight-chain or branched alkyl group, acyl group, hydroxyalkyl group, carboxyalkyl group, alkoxy group, or alkoxyalkyl group that all have 1 to 3 carbon atoms, the substituent with which the methylene carbon of acetylacetone is substituted is a carboxy group or a straight-chain or branched carboxyalkyl group or hydroxyalkyl group having 1 to 3 carbon atoms, and the substituent with which the carbonyl carbon of acetylacetone is substituted is an alkyl group having 1 to 3 carbon atoms, and in this case the carbonyl oxygen turns into a hydroxy group by addition of a hydrogen atom.

Specific preferred examples of the acetylacetone derivative include acetylacetone, ethylcarbonylacetone, n-propylcarbonylacetone, i-propylcarbonylacetone, diacetylacetone, 1-acetyl-1-propionylacetylacetone, hydroxyethylcarbonylacetone, hydroxypropylcarbonylacetone, acetoacetic acid, acetopropionic acid, diacetoacetic acid, 3,3-diacetopropionic acid, 4,4-diacetobutyric acid, carboxyethylcarbonylacetone, carboxypropylcarbonylacetone, and diacetone alcohol, and among them acetylacetone and diacetylacetone are preferable. The complex of the acetylacetone derivative and the metal element is a mononuclear complex in which 1 to 4 molecules of acetylacetone derivative coordinate to one metal element, and when the number of coordinatable sites of the metal element is larger than the total number of coordinatable bond sites of the acetylacetone derivative, a ligand that is usually used in a normal complex, such as a water molecule, a halide ion, a nitro group, or an ammonio group may coordinate thereto.

Preferred examples of the metal complex include a tris(acetylacetonato)aluminum complex salt, a di(acetylacetonato)aluminum-aqua complex salt, a mono(acetylacetonato)aluminum-chloro complex salt, a di(diacetylacetonato)aluminum complex salt, ethyl acetoacetate aluminum diisopropylate, aluminum tris(ethyl acetoacetate), cyclic aluminum oxide isopropylate, a tris(acetylacetonato)barium complex salt, a di(acetylacetonato)titanium complex salt, a tris(acetylacetonato)titanium complex salt, a di-i-propoxy-bis(acetylacetonato)titanium complex salt, zirconium tris(ethyl acetoacetate), and a zirconium tris(benzoic acid) complex salt. They are excellent in terms of stability in a coating solution and among them ethyl acetoacetate aluminum diisopropylate, aluminum tris(ethyl acetoacetate), a di(acetylacetonato)titanium complex salt, and zirconium tris(ethyl acetoacetate) are particularly preferable.

One kind of (Component C) alcohol exchange reaction catalyst may be used, and two or more kinds thereof may also be used in combination. The content is not particularly limited, and may be appropriately selected according to the characteristics of Component A, (Component F) the compound having a weight average molecular weight of less than 5,000 and having a hydrolyzable silyl group and/or silanol group, and the like that are used.

### (Component D) Radical Polymerization Initiator

The resin composition for laser engraving of the present invention preferably comprises (Component D) a radical polymerization initiator.

The radical polymerization initiator is not particularly limited and a known radical polymerization initiator may be used without particular limitations.

In the present invention, preferable radical polymerization initiators include (a) aromatic ketones, (b) onium salt compounds, (c) organic peroxides, (d) thio compounds, (e) hexaallylbiimidazole compounds, (f) ketoxime ester compounds, (g) borate compounds, (h) azinium compounds, (i) metallocene compounds, (j) active ester compounds, (k) compounds having a carbon halogen bond, and (l) azo compounds. Hereinafter, although specific examples of the (a) to (l) are cited, the present invention is not limited to these.

In the present invention, when applies to the relief-forming layer of the relief printing plate precursor, from the viewpoint of engraving sensitivity and making a favorable relief edge shape, (c) organic peroxides and (l) azo compounds are more preferable, and (c) organic peroxides are particularly preferable.

The (a) aromatic ketones, (b) onium salt compounds, (d) thio compounds, (e) hexaallylbiimidazole compounds, (f) ketoxime ester compounds, (g) borate compounds, (h) azinium compounds, (i) metallocene compounds, (j) active ester compounds, and (k) compounds having a carbon halogen bonding may preferably include compounds described in paragraphs 0074 to 0118 of JP-A-2008-63554.

Moreover, (c) organic peroxides and (l) azo compounds are preferably include the following compounds.

### (c) Organic Peroxides

Preferable (c) organic peroxides as a radical polymerization initiator that can be used in the present invention include preferably a peroxide ester such as 3,3′,4,4′-tetra(t-butylperoxycarbonyl)benzophenone, 3,3′,4,4′-tetra(t-amylperoxycarbonyl)benzophenone, 3,3′,4,4′-tetra(t-hexylperoxycarbonyl)benzophenone, 3,3′,4,4′-tetra(t-octylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone and di-t-butyldiperoxyisophthalate.

### (l) Azo Compounds

Preferable (l) azo compounds as a radical polymerization initiator that can be used in the present invention include those such as 2,2′-azobisisobutyronitrile, 2,2′-azobispropionitrile, 1,1′-azobis(cyclohexane-1-carbonitrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), dimethyl 2,2′-azobis(isobutyrate), 2,2′-azobis(2-methylpropionamideoxime), 2,2′-azobis[2-(2-imidazolin-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methyl-propionamide], 2,2′-azobis(2,4,4-trimethylpentane).

In addition, in the present invention, the (c) organic peroxides as a polymerization initiator of the invention are preferable from the viewpoint of crosslinking property of the film (relief-forming layer), furthermore, as an unexpected effect, a particularly preferable effect was found from the viewpoint of the improvement in engraving sensitivity.

With regard to (Component D) the radical polymerization initiator, one type may be used on its own or two or more types may be used in combination.

The content of (Component D) the radical polymerization initiator in the resin composition for laser engraving is preferably 0.01 to 10 wt %, and more preferably 0.1 to 3 wt %, relative to the total solids content. When the content of the radical polymerization initiator is set to 0.01 wt % or more, the effect of adding this compound may be obtained, and the crosslinking of the crosslinkable relief-forming layer occurs rapidly. Further, when the content is set to 10 wt % or less, the other components do not lack, and sufficient printing durability for the use as a relief printing plate can be obtained.

(Component E) Compound having weight average molecular weight of less than 5,000 and having polymerizable unsaturated group

It is preferable that the resin composition for laser engraving of the present invention comprises (Component E) a compound having a weight average molecular weight of less than 5,000 and having a polymerizable unsaturated group.

Component E is such that from the viewpoint of the ease of dilution with Component A, the number average molecular weight is preferably less than 2,000, and from the viewpoint of handling such as low volatility, the number average molecular weight is preferably 100 or greater.

According to the present embodiment, the content of Component E is not particularly limited, but the content is preferably at least 5 parts by weight but no greater than 100 parts by weight, and more preferably at least 10 parts by weight but no greater than 50 parts by weight, relative to 100 parts by weight of Component A. When the content of Component E is 5 parts by weight or more, the relief printing plate precursor and the relief printing plate, which are cured products of the resin composition, tend to obtain sufficient mechanical strength, and when the content is 100 parts by weight or less, the curing shrinkage of the relief printing plate precursor and the relief printing plate, which are cured products of the resin composition, tends to decrease.

Specific examples of Component E include (meth)acrylic acid and derivatives thereof, and (meth)acrylamide and derivatives thereof. From the viewpoints of the abundans of the kinds of compounds, price, and the like, (meth)acrylic acid and derivatives thereof are more preferable.

Examples of the derivatives include alicyclic compounds having a cycloalkyl group, a bicycloalkyl group, a cycloalkene group, a bicycloalkene group and the like; aromatic compounds having a benzyl group, a phenyl group, a phenoxy group, a fluorene group and the like; compounds having an alkyl group, a halogenated alkyl group, an alkoxyalkyl group, a hydroxyalkyl group, an aminoalkyl group, a glycidyl group and the like; and ester compounds with polyhydric alcohols such as alkylene glycol, polyoxyalkylene glycol, polyalkylene glycol, and trimethylolpropane.

Component E has at least one polymerizable unsaturated group in the molecule, more preferably has 2 to 6 polymerizable unsaturated groups, and even more preferably has 2 to 4 polymerizable unsaturated groups.

When the number of the polymerizable unsaturated groups in one molecule is in the range described above, the crosslinking properties with Component A is excellent.

(Component F) Compound having weight average molecular weight of less than 5,000 and having hydrolyzable silyl group and/or silanol group

The resin composition for laser engraving of the present invention preferably comprises (Component F) a compound having a weight average molecular weight of less than 5,000 and having a hydrolyzable silyl group and/or silanol group.

The ‘hydrolyzable silyl group’ of Component F is a silyl group that has a hydrolyzable group; examples of the hydrolyzable group include an alkoxy group, an aryloxy group, a mercapto group, a halogen atom, an amide group, an acetoxy group, an amino group, and an isopropenoxy group. A silyl group is hydrolyzed to become a silanol group, and a silanol group undergoes dehydration-condensation to form a siloxane bond. Such a hydrolyzable silyl group or silanol group is preferably one represented by Formula (1) below.

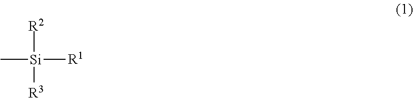

In Formula (1) above, R¹ to R³ independently denote a hydrolyzable group selected from the group consisting of an alkoxy group, an aryloxy group, a mercapto group, a halogen atom, an amide group, an acetoxy group, an amino group, and an isopropenoxy group, a hydroxy group, a hydrogen atom, or a monovalent organic group. In addition, at least one of R¹ to R³ denotes a hydrolyzable group selected from the group consisting of an alkoxy group, an aryloxy group, a mercapto group, a halogen atom, an amide group, an acetoxy group, an amino group, and an isopropenoxy group, or a hydroxy group.

A preferred organic group in a case where R¹ to R³ represents a monovalent organic group includes an alkyl group having 1 to 30 carbon atoms from the viewpoint of imparting solubility to various organic solvents.

In Formula (1) above, the hydrolyzable group bonded to the silicon atom is particularly preferably an alkoxy group or a halogen atom.

From the viewpoint of rinsing properties and printing durability, the alkoxy group is preferably an alkoxy group having 1 to 30 carbon atoms, more preferably an alkoxy group having 1 to 15 carbon atoms, yet more preferably an alkoxy group having 1 to 5 carbon atoms, particularly preferably an alkoxy group having 1 to 3 carbon atoms.

Furthermore, examples of the halogen atom include an F atom, a Cl atom, a Br atom, and an I atom, and from the viewpoint of ease of synthesis and stability it is preferably a Cl atom or a Br atom, and more preferably a Cl atom.

Component F is preferably a compound having one or more groups represented by Formula (1) above, and more preferably a compound having two or more. Component F having two or more hydrolyzable silyl groups is particularly preferably used. Component F having in the molecule two or more silicon atoms having a hydrolyzable group bonded thereto is preferably used. The number of silicon atoms having a hydrolyzable group bond thereto contained in Component F is preferably at least 2 but no greater than 6, and most preferably 2 or 3.

A range of 1 to 3 of the hydrolyzable groups may bond to one silicon atom, and the total number of hydrolyzable groups in Formula (1) is preferably in a range of 2 or 3. It is particularly preferable that three hydrolyzable groups are bonded to a silicon atom. When two or more hydrolyzable groups are bonded to a silicon atom, they may be identical to or different from each other.

Specific preferred examples of the alkoxy group include a methoxy group, an ethoxy group, a propoxy group, an isopropoxy group, a butoxy group, a tert-butoxy group, and a benzyloxy group. Examples of the alkoxysilyl group having an alkoxy group bonded thereto include a trialkoxysilyl group such as a trimethoxysilyl group, a triethoxysilyl group, a triisopropoxysilyl group; a dialkoxymonoalkylsilyl group such as a dimethoxymethylsilyl group or a diethoxymethylsilyl group; and a monoalkoxydialkylsilyl group such as a methoxydimethylsilyl group or an ethoxydimethylsilyl group. A plurality of each of these alkoxy groups may be used in combination, or a plurality of different alkoxy groups may be used in combination.

Specific examples of the aryloxy group include a phenoxy group. Examples of the aryloxysilyl group having an aryloxy group bonded thereto include a triaryloxysilyl group such as a triphenoxysilyl group.

Preferred examples of Component F in the present invention include compounds in which a plurality of groups represented by Formula (1) above are bonded via a linking group, and from the viewpoint of the effects, such a linking group is preferably a linking group having a sulfide group, an imino group or a ureylene group.

The representative synthetic method of Component F containing a linking group having a sulfide group, an imino group or ureylene group is shown below.

<Synthetic Method for Compound Having Hydrolyzable Silyl Group and/or Silanol Group and Having Sulfide Group as Linking Group>

A synthetic method for a Component F having a sulfide group as a linking group (hereinafter, called as appropriate a ‘sulfide linking group-containing Component F’) is not particularly limited, but specific examples thereof include reaction of a Component F having a halogenated hydrocarbon group with an alkali metal sulfide, reaction of a Component F having a mercapto group with a halogenated hydrocarbon, reaction of a Component F having a mercapto group with a Component F having a halogenated hydrocarbon group, reaction of a Component F having a halogenated hydrocarbon group with a mercaptan, reaction of a Component F having an ethylenically unsaturated double bond with a mercaptan, reaction of a Component F having an ethylenically unsaturated double bond with a Component F having a mercapto group, reaction of a compound having an ethylenically unsaturated double bond with a Component F having a mercapto group, reaction of a ketone with a Component F having a mercapto group, reaction of a diazonium salt with a Component F having a mercapto group, reaction of a Component F having a mercapto group with an oxirane, reaction of a Component F having a mercapto group with a Component F having an oxirane group, reaction of a mercaptan with a Component F having an oxirane group, and reaction of a Component F having a mercapto group with an aziridine.

<Synthetic Method for Compound Having Hydrolyzable Silyl Group and/or Silanol Group and Having Imino Group as Linking Group>

A synthetic method for a Component F having an imino group as a linking group (hereinafter, called as appropriate an ‘imino linking group-containing Component F’) is not particularly limited, but specific examples include reaction of a Component F having an amino group with a halogenated hydrocarbon, reaction of a Component F having an amino group with a Component F having a halogenated hydrocarbon group, reaction of a Component F having a halogenated hydrocarbon group with an amine, reaction of a Component F having an amino group with an oxirane, reaction of a Component F having an amino group with a Component F having an oxirane group, reaction of an amine with a Component F having an oxirane group, reaction of a Component F having an amino group with an aziridine, reaction of a Component F having an ethylenically unsaturated double bond with an amine, reaction of a Component F having an ethylenically unsaturated double bond with a Component F having an amino group, reaction of a compound having an ethylenically unsaturated double bond with a Component F having an amino group, reaction of a compound having an acetylenically unsaturated triple bond with a Component F having an amino group, reaction of a Component F having an imine-based unsaturated double bond with an organic alkali metal compound, reaction of a Component F having an imine-based unsaturated double bond with an organic alkaline earth metal compound, and reaction of a carbonyl compound with a Component F having an amino group.

<Synthetic Method for Compound Having Hydrolyzable Silyl Group and/or Silanol Group and Having Urea Bond (Ureylene Group) as Linking Group>

A synthetic method for a Component F having an ureylene group (hereinafter, called as appropriate a ‘ureylene linking group-containing Component F’) as a linking group is not particularly limited, but specific examples include synthetic methods such as reaction of a Component F having an amino group with an isocyanate ester, reaction of a Component F having an amino group with a Component F having an isocyanate ester, and reaction of an amine with a Component F having an isocyanate ester.

(F-1) A silane coupling agent is preferably used as Component F in the preset invention.

### (F-1) Silane Coupling Agent

Hereinafter, the silane coupling agent suitable as Component F in the present invention will be described.

In the present invention, the functional group in which an alkoxy group or a halogeno group (a halogen atom) is directly bonded to at least one Si atom is called a silane coupling group, and the compound which has one or more silane coupling groups in the molecule is also called a silane coupling agent. The silane coupling group is preferable in which two or more alkoxy groups or halogen atoms is directly bonded to Si atoms, particularly preferably three or more directly bonded to.

In the resin composition of the present invention, at least one of the hydrolyzable silyl group and silanol group in Component F, preferably a silane coupling group in (F-1) the silane coupling agent, undergoes an alcohol exchange reaction, if the reactive functional group of Component A is, for example, a hydroxyl group (—OH), with this hydroxyl group, and forms a crosslinked structure. As a result, the molecules of the binder polymer are three-dimensionally crosslinked with each other via the silane coupling agent.

In (F-1) the silane coupling agent which is a preferable aspect in the present invention, as a functional group directly bonded to the Si atom, it is indispensable to have at least one or more functional groups selected from an alkoxy group and a halogen atom, and one having an alkoxy group is preferable from the viewpoint of ease of handling of the compound.

Here, with regard to the alkoxy group from the viewpoint of rinsing properties and printing durability, an alkoxy group having 1 to 30 carbon atoms is preferable, an alkoxy group having 1 to 15 carbon atoms is more preferable, and an alkoxy group having 1 to 5 carbon atoms is yet more preferable.

Moreover, as a halogen atom, an F atom, a Cl atom, a Br atom, and an I atom are included; from the viewpoint of ease of synthesis and stability, a Cl atom and a Br atom are preferable, and a Cl atom is more preferable.

The silane coupling agent in the present invention preferably contains at least 1 but no greater than 10 of above silane coupling groups within the molecule from the viewpoint of favorably maintaining a balance of the degree of crosslinking of the film and flexibility, more preferably contains at least 1 but no greater than 5, and particularly preferably contains at least 2 but no greater than 4.

When there are two or more of silane coupling groups, it is preferable that silane coupling groups are connected with the linking group each other. As the linking group includes at least a divalent organic group which may have substituents such as a hetero atom and hydrocarbons, from the viewpoint of high engraving sensitivity, an aspect containing hetero atoms (N, S, O) is preferable, and a linking group containing an S atom is particularly preferable.

From these viewpoints, as the silane coupling agent in the present invention, a compound that having in the molecule two silane coupling groups in which the methoxy group or ethoxy group, particularly a methoxy group is bonded to a Si atom as an alkoxy group and these silane coupling groups are bonded through an alkylene group containing a hetero atom (particularly preferably a S atom) is preferable. More specifically, one having a linking group containing a sulfide group is preferable.

Moreover, as another preferred aspect of the linking group connecting together silane coupling groups, a linking group having an oxyalkylene group is included. Since the linking group contains an oxyalkylene group, rinsing properties of engraving residue after laser engraving are improved. As the oxyalkylene group, an oxyethylene group is preferable, and a polyoxyethylene chain in which a plurality of oxyethylene groups are connected is more preferable. The total number of oxyethylene groups in the polyoxyethylene chain is preferably 2 to 50, more preferably 3 to 30, particularly preferably 4 to 15.

Specific examples of the silane coupling agent that can be used in the present invention are shown below. Examples thereof include β-(3,4-epoxycyclohexyl)ethyltrimethoxysilane, γ-glycidoxypropyltrimethoxysilane, γ-glycidoxypropylmethyldiethoxysilane, γ-glycidoxypropyltriethoxysilane, N-(β-aminoethyl)-γ-aminopropylmethyldimethoxysilane, N-(β-aminoethyl)-γ-aminopropyltrimethoxysilane, N-(β-aminoethyl)-γ-aminopropyltriethoxysilane, γ-aminopropyltrimethoxysilane, γ-aminopropyltriethoxysilane, N-phenyl-γ-aminopropyltrimethoxysilane, γ-mercaptopropyltrimethoxysilane, γ-mercaptopropyltriethoxysilane, bis(triethoxysilylpropyl)disulfide, bis(triethoxysilylpropyl)tetrasulfide, 1,4-bis(triethoxysilyl)benzene, bis(triethoxysilyl)ethane, 1,6-bis(trimethoxysilyl)hexane, 1,8-bis(triethoxysilyl)octane, 1,2-bis(trimethoxysilyl)decane, bis(triethoxysilylpropyl)amine, bis(trimethoxysilylpropyl)urea, γ-chloropropyltrimethoxysilane, γ-ureidopropyltriethoxysilane. Other than the above, the compounds shown below can be cited as preferred examples, but the present invention should not be construed as being limited thereto.

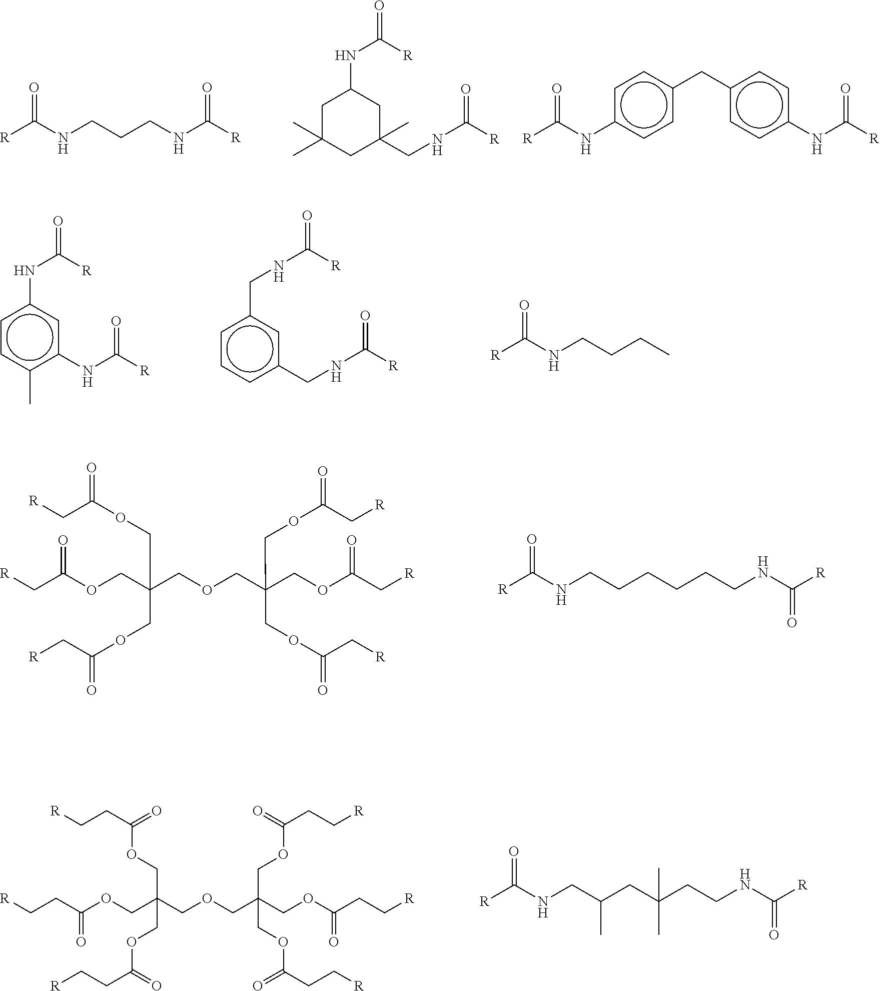

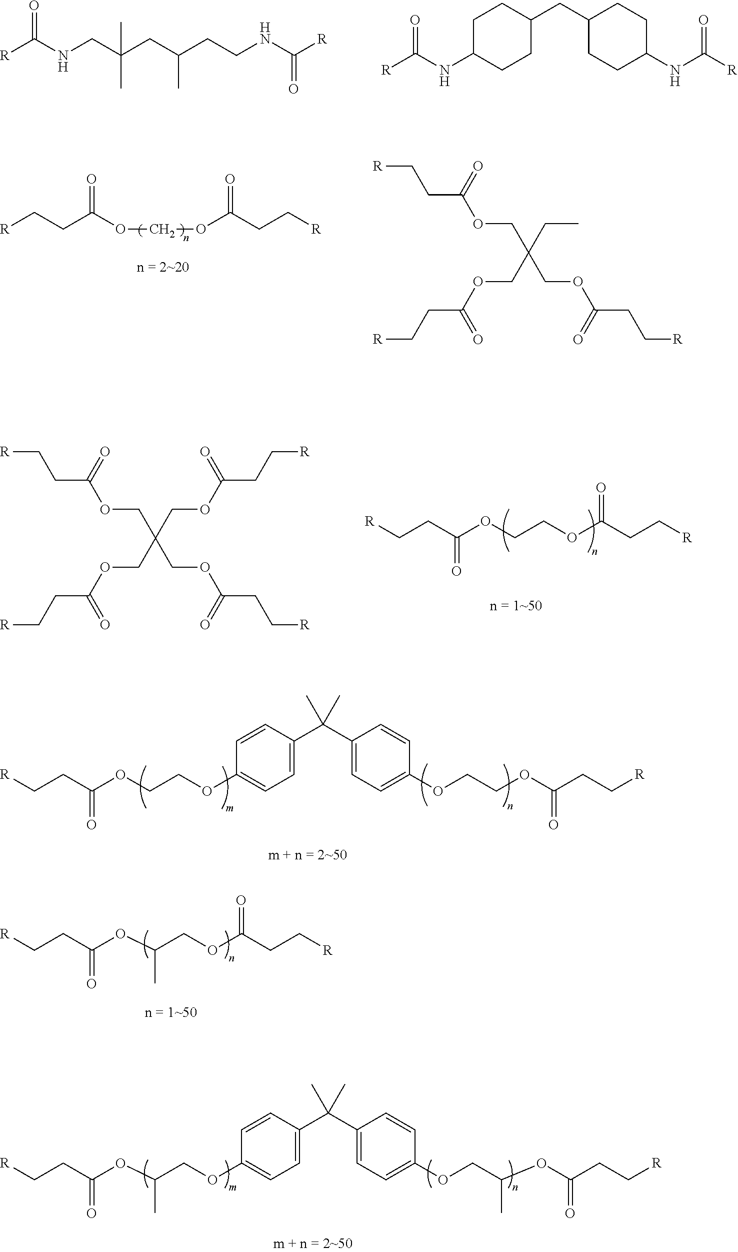

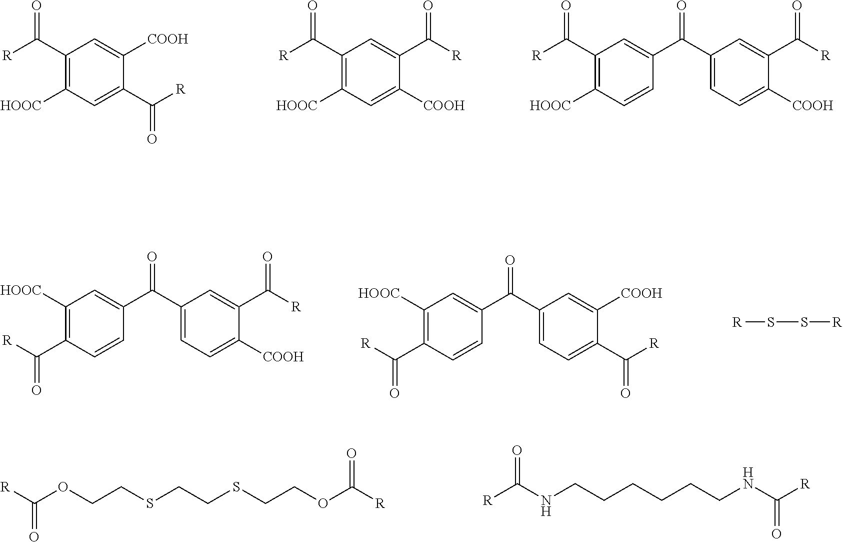

In each of the formulae above, R denotes a partial structure selected from the structures below. When a plurality of Rs and R¹s are present in the molecule, they may be identical to or different from each other, and are preferably identical to each other in terms of synthetic suitability. Et in the chemical formulae below is an ethyl group, and Me is a methyl group.

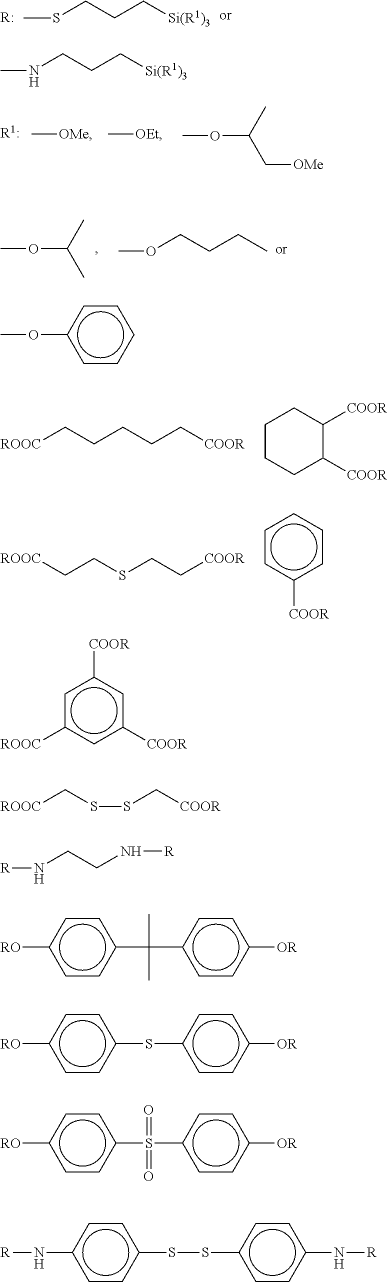

In each of the formulae above, R denotes a partial structure selected from the structures below. R¹ is the same as defined above. When a plurality of Rs and R¹s are present in the molecule, they may be identical to or different from each other, and are preferably identical to each other in terms of synthetic suitability.

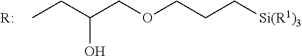

Component F may be obtained by synthesis as appropriate, but use of a commercially available product is preferable in terms of cost. Since Component F corresponds to for example commercially available silane products or silane coupling agents from Shin-Etsu Chemical Co., Ltd., Dow Corning Toray, Momentive Performance Materials Inc., Chisso Corporation, etc., the resin composition of the present invention may employ such a commercially available product by appropriate selection according to the intended application.

As the silane coupling agent in the present invention, a partial hydrolysis-condensation product obtained using one type of compound having a hydrolyzable silyl group and/or a silanol group or a partial cohydrolysis-condensation product obtained using two or more types may be used. Hereinafter, these compounds may be called ‘partial (co)hydrolysis-condensation products’.

Specific examples of such a partial (co)hydrolysis-condensation product include a partial (co)hydrolysis condensate obtained by using, as a precursor, one or more compound selected from the group of silane compounds consisting of alkoxysilanes or acetyloxysilanes such as tetramethoxysilane, tetraethoxysilane, methyltrimethoxysilane, methyltriethoxysilane, methyltriisopropoxysilane, methyltriacetoxysilane, methyltris(methoxyethoxy)silane, methyltris(methoxypropoxy)silane, ethyltrimethoxysilane, propyltrimethoxysilane, butyl trimethoxysilane, hexyltrimethoxysilane, octyltrimethoxysilane, decyltrimethoxysilane, cyclohexyltrimethoxysilane, phenyltrimethoxysilane, phenyltriethoxysilane, tolyltrimethoxysilane, chloromethyltrimethoxysilane, γ-chloropropyltrimethoxysilane, 3,3,3-trifluoropropyltrimethoxysilane, cyanoethyltriethoxysilane, γ-glycidoxypropyltrimethoxysilane, γ-glycidoxypropyltriethoxysilane, β-(3,4-epoxycyclohexyl)ethyltrimethoxysilane, γ-aminopropyltrimethoxysilane, γ-aminopropyltriethoxysilane, N-β-(aminoethyl)-γ-aminopropyltrimethoxysilane, N-phenyl-γ-aminopropyltrimethoxysilane, γ-mercaptopropyltrimethoxysilane, dimethyldimethoxysilane, dimethyldiethoxysilane, diethyldimethoxysilane, methylethyldimethoxysilane, methylpropyldimethoxysilane, diphenyldimethoxysilane, diphenyldiethoxysilane, methylphenyldimethoxysilane, γ-chloropropylmethyldimethoxysilane, 3,3,3-trifluoropropylmethyldimethoxysilane, γ-glycidoxypropylmethyldiethoxysilane, γ-aminopropylmethyldiethoxysilane, N-β-(aminoethyl)-γ-aminopropylmethyldimethoxysilane and γ-mercaptopropylmethyldiethoxysilane, and an acyloxysilane such as ethoxalyloxysilane.

Among silane compounds as partial (co)hydrolysis-condensation product precursors, from the viewpoint of versatility, cost, and film compatibility, a silane compound having a substituent selected from a methyl group and a phenyl group as a substituent on the silicon is preferable. Specific preferred examples of the precursor include methyltrimethoxysilane, methyltriethoxysilane, phenyltrimethoxysilane, phenyltriethoxysilane, dimethyldimethoxysilane, dimethyldiethoxysilane, diphenyldimethoxysilane, and diphenyldiethoxysilane.

In this case, as a partial (co)hydrolysis-condensation product, it is preferable to use a dimer (2 moles of silane compound is reacted with 1 mole of water to eliminate 2 moles of alcohol, thus giving a disiloxane unit) of the silane compounds cited above to 100-mer of the above-mentioned silane compound, more preferably a dimer to 50-mer, and yet more preferably a dimer to 30-mer, and it is also possible to use a partial (co)hydrolysis-condensation product formed using two or more types of silane compounds as starting materials.

As such a partial (co)hydrolysis-condensation product, ones commercially available as silicone alkoxy oligomers may be used (e.g. those from Shin-Etsu Chemical Co., Ltd.) or ones that are produced in accordance with a standard method by reacting a hydrolyzable silane compound with less than an equivalent of hydrolytic water and then removing by-products such as alcohol and hydrochloric acid may be used. When the production employs, for example, an acyloxysilane or an alkoxysilane described above as a hydrolyzable silane compound starting material, which is a precursor, partial hydrolysis-condensation may be carried out using as a reaction catalyst an acid such as hydrochloric acid or sulfuric acid, an alkali metal or alkaline earth metal hydroxide such as sodium hydroxide or potassium hydroxide, or an alkaline organic material such as triethylamine, and when the production is carried out directly from a chlorosilane, water and alcohol may be reacted using hydrochloric acid by-product as a catalyst.

Component F, preferably (F-1) the silane coupling agent, in the resin composition of the present invention is such that only one kind may be used, or two or more kinds may be used in combination.

The content of Component F contained in the resin composition of the present invention is preferably in the range of 0.1 wt % to 80 wt %, more preferably in the range of 1 wt % to 60 wt %, and most preferably 5 wt % to 45 wt %, relative to the solids content.

(Component G) Photothermal Conversion Agent Capable of Absorbing Light Having a Wavelength of 700 to 1,300 nm

The resin composition for laser engraving of the present invention preferably further comprises (Component G) a photothermal conversion agent capable of absorbing light having a wavelength of 700 to 1,300 nm (hereinafter, simply called “photothermal conversion agent”).

That is, it is considered that the photothermal conversion agent in the present invention can promote the thermal decomposition of a cured material during laser engraving by absorbing laser light and generating heat. Therefore, it is preferable that a photothermal conversion agent capable of absorbing light having a wavelength of laser used for engraving be selected.

When a laser (a YAG laser, a semiconductor laser, a fiber laser, a surface emitting laser, etc.) emitting infrared at a wavelength of 700 to 1,300 nm is used as a light source for laser engraving, it is preferable for the relief-forming layer in the present invention to comprise a photothermal conversion agent that has a maximum absorption wavelength at 700 to 1,300 nm.

As the photothermal conversion agent in the present invention, various types of dye or pigment are used.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific examples include dyes having a maximum absorption wavelength at 700 to 1,300 nm, such as azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium colorants, pyrylium salts, and metal thiolate complexes.

In particular, cyanine-based colorants such as heptamethine cyanine colorants, oxonol-based colorants such as pentamethine oxonol colorants, and phthalocyanine-based colorants are preferably used. Examples include dyes described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saishin Ganryo Ouyogijutsu’ (Latest Applications of Pigment Technology) (CMC Publishing, 1986), ‘Insatsu Inki Gijutsu’ (Printing Ink Technology) (CMC Publishing, 1984).

Examples of the type of pigment include a black pigment, a yellow pigment, an orange pigment, a brown pigment, a red pigment, a purple pigment, a blue pigment, a green pigment, a fluorescent pigment, a metal powder pigment and, in addition, polymer-binding dyes. Specifically, an insoluble azo pigment, an azo lake pigment, a condensed azo pigment, a chelate azo pigment, a phthalocyanine type pigment, an anthraquinone type pigment, perylene and perinone type pigments, a thioindigo type pigment, a quinacridone type pigment, a dioxazine type pigment, an isoindolinone type pigment, a quinophthalone type pigment, a dye lake pigment, an azine pigment, a nitroso pigment, a nitro pigment, a natural pigment, a fluorescent pigment, an inorganic pigment, carbon black, etc. may be used. Among these pigments, carbon black is preferable.

Any carbon black, regardless of classification by ASTM (American Society for Testing and Materials) and application (e.g. for coloring, for rubber, for dry cell, etc.), may be used as long as dispersibility, etc. in the resin composition for laser engraving is stable. Carbon black includes for example furnace black, thermal black, channel black, lamp black, and acetylene black. In order to make dispersion easy, a black colorant such as carbon black may be used as color chips or a color paste by dispersing it in nitrocellulose or a binder in advance using, as necessary, a dispersant, and such chips and paste are readily available as commercial products.

In the present invention, it is possible to use carbon black having a relatively low specific surface area and a relatively low dibutyl phthalate (DBP) absorption and also finely divided carbon black having a large specific surface area. Preferred examples of carbon black include Printex (registered trademark) U, Printex (registered trademark) A, and Spezialschwarz (registered trademark) 4 (Degussa).

From the viewpoint of improving engraving sensitivity by efficiently transmitting heat generated by photothermal conversion to the surrounding polymer, etc., the carbon black that can be used in the present invention is preferably a conductive carbon black having a specific surface area of at least 150 m²/g and a DBP number of at least 150 mL/100 g.

This specific surface area is preferably at least 250 m²/g, and particularly preferably at least 500 m²/g. The DBP number is preferably at least 200 mL/100 g, and particularly preferably at least 250 mL/100 g. The above-mentioned carbon black may be acidic or basic carbon black. The carbon black is preferably basic carbon black. It is of course possible to use a mixture of different carbon blacks.

Conductive carbon black having a specific surface area of extend to about 1,500 m²/g and a DBP number of extend to about 550 mL/100 g is commercially available under names such as for example Ketjenblack (registered trademark) EC300J, Ketjenblack (registered trademark) EC600J (Akzo), Printex (registered trademark) XE (Degussa), Black Pearls (registered trademark) 2000 (Cabot), and Ketjen Black (Lion Corporation).

When carbon black is used as the photothermal conversion agent, thermal crosslinking is more preferable in point of the curability of the film, instead of the photo crosslinking using UV light etc., and, by the combination with (c) the organic peroxide being (Component D) the radical polymerization initiator, which is the aforementioned preferable component for use in combination, the engraving sensitivity becomes extremely high, more preferably.

The content of the photothermal conversion agent in the resin composition for laser engraving greatly varies depending on the molecular extinction coefficient inherent to the molecule, and, relative to the total solid content of the resin composition, 0.01 to 20 wt % is preferable, 0.5 to 15 wt % is more preferable, and 1 to 10 wt % is particularly preferable.

### <Other Additives>

The resin composition for laser engraving of the present invention contains preferably a plasticizer. The plasticizer is a material having the function of softening the film formed with the resin composition for laser engraving, and has necessarily a good compatibility relative to the binder polymer.

As the plasticizer, for example, dioctyl phthalate, didodecyl phthalate, polyethylene glycols, and polypropylene glycols (such as monool type and diol type) are used preferably.

The resin composition for laser engraving of the present invention preferably comprises, as an additive for improving engraving sensitivity, nitrocellulose or a high thermal conductivity material. Since nitrocellulose is a self-reactive compound, it generates heat during laser engraving, thus assisting thermal decomposition of a coexisting binder polymer such as a hydrophilic polymer. It is surmised that as a result, the engraving sensitivity improves. A high thermal conductivity material is added for the purpose of assisting heat transfer, and examples of thermal conductive materials include inorganic compounds such as metal particles and organic compounds such as a conductive polymer. As the metal particles, fine gold particles, fine silver particles, and fine copper particles having a particle diameter of on the order of from a micrometer to a few nanometers are preferable. As the conductive polymer, a conjugated polymer is particularly preferable, and specific examples thereof include polyaniline and polythiophene.

Moreover, the use of a cosensitizer can furthermore improve the sensitivity in curing the resin composition for laser engraving with light.

Furthermore, a small amount of thermal polymerization inhibitor is added preferably for the purpose of hindering unnecessary thermal polymerization of a polymerizable compound during the production or storage of the composition.

For the purpose of coloring the resin composition for laser engraving, a colorant such as a dye or a pigment may be added. This enables properties such as visibility of an image area or suitability for an image densitometer to improve.

Furthermore, in order to improve physical properties of a cured film of the resin composition for laser engraving, a known additive such as a filler may be added.

### (Relief Printing Plate Precursor and Relief Printing Plate)

A relief printing plate precursor of the present invention comprises a relief-forming layer formed from the resin composition for laser engraving comprising the above-mentioned components. The relief-forming layer is preferably provided above a support.

In the present invention, the ‘relief printing plate precursor for laser engraving’ means a plate having a crosslinked relief-forming layer formed from the resin composition for laser engraving in a state in which it is cured by light and/or heat.

In the present invention, the ‘relief-forming layer’ means a layer in a state being cured by light and/or heat, and preferably in a state being cured by heat.

The relief printing plate precursor for laser engraving may further comprise, as necessary, an adhesive layer between the support and the relief-forming layer and, above the relief-forming layer, a slip coat layer and a protection film.

### <Relief-Forming Layer>

The relief-forming layer is a layer formed from the resin composition for laser engraving according to the present invention as described above. When a crosslinkable resin composition is used as the resin composition for laser engraving, a crosslinkable relief-forming layer is obtained. As for the relief printing plate precursor for laser engraving of the present invention, in addition to the crosslinked structure resulting from Component A, it is preferable that the relief printing plate precursor has a relief-forming layer further imparted with a function of crosslinkability by containing Component B, Component D, Component E and Component F.

As a mode in which a relief printing plate is prepared using the relief printing plate precursor for laser engraving, a mode in which a relief printing plate is prepared by crosslinking a layer of the resin composition for laser engraving of the present invention to thus form a relief printing plate precursor having a crosslinked relief-forming layer, and the crosslinked relief-forming layer (hard relief-forming layer) is then laser-engraved to thus form a relief layer is preferable. By crosslinking the relief-forming layer, it is possible to prevent abrasion of the relief layer during printing, and it is possible to obtain a relief printing plate having a relief layer with a sharp shape after laser engraving.

The relief-forming layer may be formed by molding the resin composition for laser engraving that has the above-mentioned components for a relief-forming layer into a sheet shape or a sleeve shape and being crosslinked. The relief-forming layer is usually provided above a support, which is described later, but it may be formed directly on the surface of a member such as a cylinder of equipment for plate making or printing or may be placed and immobilized thereon, and a support is not always required.

A case in which the relief-forming layer is mainly formed in a sheet shape is explained as an example below.

### <Support>

A support that can be used for the relief printing plate precursor for laser engraving is explained below.

A material used for the support of the relief printing plate precursor for laser engraving is not particularly limited, but one having high dimensional stability is preferably used, and examples thereof include metals such as steel, stainless steel, or aluminum, plastic resins such as a polyester (e.g. PET (polyethylene terephthalate), PBT (polybutylene terephthalate), or PAN (polyacrylonitrile)) or polyvinyl chloride, synthetic rubbers such as styrene-butadiene rubber, and glass fiber-reinforced plastic resins (epoxy resin, phenolic resin, etc.). As the support, a PET film or a steel substrate is preferably used. The configuration of the support depends on whether the relief-forming layer is in a sheet shape or a sleeve shape.

A preferable support in the case of being manufactured in a sleeve shape will be described in detail below.

### <Adhesive Layer>

In the case of forming a relief-forming layer on the support, an adhesive layer may be provided between the two for the purpose of strengthening the adhesive force between the layers.

The material that can be used in the adhesive layer may be any material which strengthens the adhesive force after the relief-forming layer is crosslinked, and is preferably a material which gives a firm adhesive force even before the relief-forming layer is crosslinked. Here, the adhesive force means both the adhesive force between the support/adhesive layer and the adhesive force between the adhesive layer/relief-forming layer.

The adhesive force between the support/adhesive layer is such that when the adhesive layer and the relief-forming layer are peeled from a laminate consisting of support/adhesive layer/relief-forming layer at a rate of 400 mm/min, the peeling force with respect to a width of 1 cm of the sample is preferably 1.0 N/cm or greater or unpeelable, and more preferably 3.0 N/cm or greater or unpeelable.

The adhesive force between the adhesive layer/relief-forming layer is such that when the adhesive layer is peeled from the adhesive layer/relief-forming layer at a rate of 400 mm/min, the peeling force with respect to a width of 1 cm of the sample is preferably 1.0 N/cm or greater or unpeelable, and more preferably 3.0 N/cm or greater or unpeelable.

As the material (adhesive) that can be used in the adhesive layer, for example, the materials described in I. Skeist, ed., “Handbook of Adhesives”, Second Edition (1977) can be used.

### <Protective Film, Slip Coat Layer>

The relief-forming layer serves as the part where relief is to be formed after laser engraving (relief layer), and the surface of the relief layer functions as an ink-receiving section. Since the relief-forming layer after crosslinking has been strengthened by the crosslinking, there is almost no chance that damage or dents occur on the surface of the relief-forming layer to the extent of affecting printing. However, the relief-forming layer before crosslinking often has insufficient strength, so that damage or dents are likely to occur on the surface. From this point of view, a protective film may be provided on the surface of the relief-forming layer for the purpose of preventing damage or dents on the surface of the relief-forming layer.

The protective film is such that if the film is too thin, the effect of preventing damage or dents is not obtained, and if the film is too thick, handling is inconvenient, while the cost increases. Therefore, the thickness of the protective film is preferably 25 μm to 500 μm, and more preferably 50 μm to 200 μm.

The protection film may employ any materials known as a protection film of a printing plate, and examples thereof include a polyester-based film such as PET (polyethylene terephthalate) or a polyolefin-based film such as PE (polyethylene) or PP (polypropylene). The surface of the film may be plane, or made matte.

In a case in which the protection film is provided above the relief-forming layer, the protection film must be peelable.

When the protection film is not peelable or conversely has poor adhesion to the relief-forming layer, a slip coat layer may be provided between the two layers.

The material used in the slip coat layer preferably employs as a main component a resin that is soluble or dispersible in water and has little tackiness, such as polyvinyl alcohol, polyvinyl acetate, partially saponified polyvinyl alcohol, a hydroxyalkylcellulose, an alkylcellulose, or a polyamide resin. Among them, from the viewpoint of tackiness, partially saponified polyvinyl alcohol having a saponification value of 60 to 99 mole %, and a hydroxyalkyl cellulose and a alkylcellulose having an alkyl group of 1 to 5 carbon atoms are preferable.

When the protective film is peeled from the relief-forming layer (and slip coat layer)/protective film at a rate of 200 mm/min, the peeling force per centimeter (cm) is preferably 5 to 200 mN/cm, and more preferably 10 to 150 mN/cm. If the peeling force is 5 mN/cm or more, the operation can be carried out without the protective film being peeled off during the operation, and if the peeling force is 200 mN/cm or less, the protective film can be peeled without difficulty.

### (Process for Producing Relief Printing Plate Precursor for Laser Engraving)

A process for producing relief printing plate precursor for laser engraving is explained hereafter.

Formation of a relief-forming layer in the relief printing plate precursor for laser engraving is not particularly limited, and examples thereof include a method in which the resin composition for laser engraving is prepared, solvent is removed as necessary from this resin composition for laser engraving, and it is melt-extruded onto a support. Alternatively, a method may be employed in which the resin composition for laser engraving is cast onto a support, and this is dried in an oven to thus remove solvent from the resin composition.

Subsequently, as necessary, a protection film may be laminated on the relief-forming layer. Laminating may be carried out by compression-bonding the protection film and the relief-forming layer by means of heated calendar rollers, etc. or putting a protection film into intimate contact with a relief-forming layer whose surface is impregnated with a small amount of solvent.

When a protection film is used, a method in which a relief-forming layer is first layered on a protection film and a support is then laminated may be employed.

When an adhesive layer is provided, it may be dealt with by use of a support coated with an adhesive layer. When a slip coat layer is provided, it may be dealt with by use of a protection film coated with a slip coat layer.

The coating liquid composition for forming the relief-forming layer can be prepared by dissolving all the components in an appropriate solvent; however, the coating liquid composition can also be prepared by dissolving each of the components, or various kinds of components together, in an appropriate solvent, and mixing these solutions, or can also be prepared by appropriately selecting the order of the addition to the solvent.

As for the solvent, it is preferable to use a solvent which contains an aprotic solvent as a main component, and since it is necessary to eliminate most of the solvent component in the stage of producing the printing plate precursor, it is preferable to suppress the total amount of the solvent to be added to a minimal level. When the system is brought to a high temperature, the amount of the solvent to be added can be suppressed. However, if the temperature is too high, because the polymerizable compounds are prone to undergo polymerization reactions, the preparation temperature of the coating liquid composition after the addition of polymerizable compounds and/or a polymerization initiator is preferably 30° C. to 80° C.

The thickness of the relief-forming layer in the relief printing plate precursor for laser engraving before and after crosslinking is preferably at least 0.05 mm but no greater than 10 mm, more preferably at least 0.05 mm but no greater than 7 mm, and yet more preferably at least 0.05 mm but no greater than 3 mm.

Next, the case of forming the relief-forming layer in a sleeve shape will be explained. Even in the case of molding the relief-forming layer in a sleeve shape, known resin molding methods can be applied. Examples include a casting method, and methods of extruding a resin through a nozzle or a die with a machine such as a pump or an extruder, adjusting the thickness with a blade, and calendar processing the resin with a roller to adjust the thickness. In that case, molding may be performed while the resin is heated to a temperature to the extent that the characteristics of the resin composition constituting the relief-forming layer are not impaired. Furthermore, if necessary, a rolling treatment, a grinding treatment and the like may be applied.

When the relief-forming layer is made into a sleeve shape, the relief-forming layer itself may be molded in a cylindrical shape from the beginning, or the relief-forming layer may be first molded in a sheet shape and then fixed on a cylindrical support or on a plate cylinder to obtain a cylindrical shape. The method for fixing the relief-forming layer to a cylindrical support is not particularly limited, and for example, fixing on an adhesive tape where an adhesive layer, a tacky layer or the like is formed on both sides of the tape, or fixing via an adhesive layer can be carried out.

### (Relief Printing Plate and Method for Making the Same)

The method for making a relief printing plate using the relief printing plate precursor of the present invention preferably includes (1) a step of crosslinking the relief-forming layer in the relief printing plate precursor for laser engraving of the present invention by light (irradiation of an active radiation) and/or heat (heating), and (2) a step of laser-engraving the crosslinked relief-forming layer to form a relief layer. A relief printing plate having a relief layer can be made by such a plate-making method using the relief printing plate precursor of the present invention. When the relief printing plate precursor of the present invention includes a support, such a relief layer is formed on the surface of the support, so that this is applied to a printing apparatus, and printing is performed.

A preferable method for making a relief printing plate according to the present invention may further include, subsequently to Step (2), following Step (3) to Step (5) as necessary.

Step (3): A step of rinsing the engraved surface, which is the surface of the relief layer after engraving, with water or a liquid containing water as a main component (rinsing step).

Step (4): A step of drying the engraved relief layer (drying step).

Step (5): A step of applying energy to the relief layer after engraving to further crosslink the relief layer (post-crosslinking step).

The crosslinking of the relief-forming layer in Step (1) is carried out by irradiation with an active radiation (light) and/or heat.

In Step (1) the crosslinking of the relief-forming layer, when a step of crosslinking by light and a step of crosslinking by heat are used in combination, these steps may be mutually simultaneous steps or may be separate time steps.

Step (1) is a step of crosslinking the relief-forming layer of the relief printing plate precursor for laser engraving, by light and/or heat.

The polymerization initiator is preferably a radical generator, and the radical generators are broadly classified into photopolymerization initiators and thermal polymerization initiators, depending on whether the cause of generating a radical is light or heat.

When the relief-forming layer contains a photopolymerization initiator, the relief-forming layer can be crosslinked by irradiating the relief-forming layer with an active radiation that triggers the photopolymerization initiator (step of crosslinking by light).

The irradiation of an active radiation is generally carried out over the entire surface of the relief-forming layer. Examples of the active radiation include visible light, ultraviolet radiation, or an electron beam, but ultraviolet radiation is most commonly used. When the side of a base material for fixing the relief-forming layer, such as the support of the relief-forming layer, is designated as a back surface, it is acceptable to irradiate only the front surface with an active radiation, but if the support used is a transparent film which transmits the active radiation, it is also preferable to further irradiate the active radiation from the back surface. The irradiation from the front surface may be carried out, in the case where a protective film is present, while the protective film has been provided, or may be carried out after the protective film is peeled. In the presence of oxygen, there is a risk that inhibition of polymerization may occur; therefore, the irradiation of an active radiation may be carried out after covering the crosslinkable relief-forming layer with a vinyl chloride sheet and applying a vacuum.

When the relief-forming layer contains a thermal polymerization initiator (the photopolymerization initiator may also act as a thermal polymerization initiator), the relief-forming layer can be crosslinked by heating the relief printing plate precursor for laser engraving (step of crosslinking by heat). Examples of the heating means include a method of heating the printing plate precursor in a hot air oven or an infrared oven for a predetermined time, and a method of bringing the printing plate precursor into contact with a heated roller for a predetermined time.

When Step (1) is a step of crosslinking by light, because the apparatus for irradiating an active radiation is relatively expensive, there is no chance that the printing plate precursor is brought to a high temperature. Therefore, there are little restrictions on the raw material of the printing plate precursor.

When Step (1) is a step of crosslinking by heat, it is advantageous that an especially expensive apparatus is not required; however, since the printing plate precursor is brought to a high temperature, a thermoplastic polymer which is softened at a high temperature has a possibility of being deformed during heating, and thus, the raw material to be used needs to be carefully selected.

During thermal crosslinking, a thermal polymerization initiator can be added. As the thermal polymerization initiator, commercial thermal polymerization initiators for free radical polymerization can be used. Examples of such a thermal polymerization initiator include appropriate peroxides, hydroperoxides, or compounds containing an azo group. Representative vulcanizing agents can also be used for crosslinking. Thermal crosslinking can also be carried out by adding a heat-curable resin, for example, an epoxy resin as a crosslinking component, to the layer.

In regard to the method of crosslinking the relief-forming layer in Step (1), from the viewpoint of being capable of curing (crosslinking) the relief-forming layer from the surface to the inside, crosslinking by heat is preferable.

When the relief-forming layer is crosslinked, there are advantages that firstly, the relief formed after laser engraving becomes sharp, and secondly, the adhesiveness of the engraving residue generated at the time of laser-engraving is suppressed. When an uncrosslinked relief-forming layer is laser-engraved, the areas that are not originally intended are likely to melt and deform due to the remaining heat dissipated to the surroundings of the laser-irradiated areas, and a sharp relief layer may not be obtained. Furthermore, as a general property of a material, as the molecular weight of the material is lower, the material becomes not solid but liquid, that is, the material tends to have stronger adhesiveness. The engraving residue that is generated when the relief-forming layer is engraved, has a tendency that as a low molecular weight material is used in a larger amount, the adhesiveness becomes stronger. Since low molecular weight polymerizable compounds obtain high molecular weights by crosslinking, the engraving residue thus generated tends to have decreased adhesiveness.

Step (2) is a step of forming a relief layer by laser-engraving the crosslinked relief-forming layer. In Step (2), it is preferable to form a relief by irradiating a laser light corresponding to an image that is wished to form, by a specific laser that will be described later, and to form a relief layer for printing.

Specifically, a relief layer is formed by irradiating the crosslinked relief-forming layer with a laser light corresponding to an image that is wished to form, and performing engraving. Preferably, a step of controlling the laser head with a computer based on the digital data of an image that is wished to form, and scan irradiating the relief-forming layer, may be mentioned. When an infrared laser light is irradiated, the molecules in the relief-forming layer have molecular vibration, and heat is generated. When a high output power laser such as a carbon dioxide gas laser or a YAG laser is used as the infrared laser, a large amount of heat is generated at the laser-irradiated areas, the molecules in the relief-forming layer undergo molecular cleavage or ionization, and selective removal, that is, engraving, is achieved. In this case, since exposed regions generate heat also due to the photothermal conversion agent in the relief-forming layer, the heat generated by this photothermal conversion agent also promotes the removability of this.

An advantage of laser-engraving is that since the engraving depth can be set arbitrarily, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for the groove to be blocked with ink, thus enabling breakup of an outline character to be suppressed.

Inter alia, when engraving is carried out using an infrared laser corresponding to the maximum absorption wavelength of the photothermal conversion agent, the heat generation by the photothermal conversion agent as described above is carried out efficiently, and therefore, a sharp relief layer with higher sensitivity is obtained.

As the infrared laser to be used in engraving, in view of productivity, cost and the like, a carbon dioxide gas laser or a semiconductor laser is preferably used, and among them, a fiber-coupled semiconductor infrared laser that will be described in detail below is particularly preferably used.

(Plate-Making Apparatus Equipped with Semiconductor Laser)

In general, it is possible for semiconductor lasers to have highly efficient laser oscillation as compared with CO₂ laser, miniaturization is possible, and the cost is low. Furthermore, since the semiconductor lasers are small-sized, arraying is easily achieved. The control of the beam diameter is achieved by using imaging lenses and specific optical fibers. Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2nd Edition’ The Laser Society of Japan, and ‘Applied Laser Technology’ The Institute of Electronics and Communication Engineers, etc.

Moreover, as plate making equipment comprising a fiber-coupled semiconductor laser that can be used suitably in the process for making a relief printing plate employing the relief printing plate precursor of the present invention, those described in detail in JP-A-2009-172658 and JP-A-2009-214334 can be cited.

As the semiconductor laser used in laser engraving, a semiconductor laser having a wavelength of 700 nm to 1,300 nm can be used, but a semiconductor laser having a wavelength of 800 nm to 1,200 nm is preferable, a semiconductor laser having a wavelength of 860 nm to 1,200 nm is more preferable, and a semiconductor laser having a wavelength of 900 nm to 1,100 nm is particularly preferable.

Since the bandgap of GaAs is 860 nm at room temperature, in the region of less than 860 nm, generally, an active layer of an AlGaAs system is used. On the other hand, in the region of 860 nm or greater, a semiconductor active layer material of an InGaAs system is used. Generally, since Al is easily oxidized, a semiconductor laser having an InGaAs system material in the active layer has higher reliability than a semiconductor laser having an AlGaAs system, and therefore, a semiconductor laser having a wavelength of 860 nm to 1,200 nm is preferable.

Furthermore, as a practical semiconductor laser, when the compositions of not only the active layer material but also the cladding material are considered, in regard to a semiconductor laser having an InGaAs system material in the active layer, according to a more preferred embodiment, a highly reliable semiconductor laser with a higher output power can be easily obtained in the wavelength range of 900 nm to 1,100 nm. Therefore, when a fiber-coupled semiconductor laser having an InGaAs system material having a wavelength of 900 nm to 1,100 nm is used, low cost and high productivity, which are the effects of the present invention, can be easily achieved.

In order to realize a laser engraving relief printing system at low cost with high productivity and with satisfactory image quality, it is preferable to use a relief printing plate precursor including a relief-forming layer using the resin composition for laser engraving as defined in the present invention, and also to use a fiber-coupled semiconductor laser, which is a semiconductor laser having a specific wavelength such as described above.

When a fiber-coupled semiconductor laser is used, there is also an advantage that in the control of the figure that is wished to engrave, it is possible to change the figure of the engraved region by changing the beam shape of the fiber-coupled semiconductor laser, or by changing the amount of energy supplied to the laser, without changing the beam shape.

After carrying out the steps described above, because engraving residue is adhering to the engraved surface, it is preferable to perform Rinsing Step (3) of rinsing the engraved surface with water or a liquid containing water as a main component, and washing away the engraving residue. Examples of rinsing means include a method of spray jetting high pressure water, and a method of brushing the engraved surface, mainly in the presence of water, with a batch type or conveying type brush washout machine, which is known as a developing machine for photosensitive resin relief plates. According to the present invention, since the engraving residue generated is in a powder form without any slime or the like, the residue is effectively removed by a step of rinsing with water. Therefore, there is no need to use, for example, a rinsing liquid containing added soap.

When Rinsing Step (3) has been performed on the engraved surface, it is preferable to add Step (4) of drying the engraved relief-forming layer to volatilize the rinsing liquid.

Furthermore, if necessary, Step (5) of further crosslinking the relief-forming layer may also be added. When additional Crosslinking Step (5) (post-crosslinking treatment) is carried out, the relief formed by engraving can be further strengthened.

The relief printing plate of the present invention having a relief layer on the surface of any substrate such as a support etc. may be produced as described above.

From the viewpoint of satisfying suitability for various aspects of printing, such as abrasion resistance and ink transfer properties, the thickness of the relief layer of the relief printing plate is preferably at least 0.05 mm but no greater than 10 mm, more preferably at least 0.05 mm but no greater than 7 mm, and yet more preferably at least 0.05 mm but no greater than 3 mm.

Furthermore, the Shore A hardness of the relief layer of the relief printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured at 25° C. by a durometer (a spring type rubber hardness meter) that presses an indenter (called a pressing needle or indenter) into the surface of a measurement target so as to deform it, measures the amount of deformation (indentation depth), and converts it into a numerical value.

The relief printing plate which is produced from the relief printing plate precursor of the present invention is particularly suitable for printing by a relief printer using any of an aqueous, oil-based, and UV inks, and printing is also possible when it is carried out by a flexographic printer using a UV ink. The relief printing plate produced from the relief printing plate precursor of the present invention has excellent rinsing properties, there is less engraving residue, since a relief layer obtained has excellent elasticity, ink transfer properties and printing durability are excellent, and printing can be carried out for a long period of time without plastic deformation of the relief layer or degradation of printing durability.

According to the present invention, it was possible to provide a resin composition for laser engraving from which a relief printing plate having excellent laser engraving sensitivity, rinsing properties, ink transferability, printing durability and peeling resistance can be obtained, a relief printing plate precursor using the resin composition for laser engraving, a process for making a relief printing plate using the relief printing plate precursor, and a relief printing plate obtained by the process.

### Example

Hereinafter, the present invention will be described in further detail with reference to Examples, but the present invention is not limited to Examples. However, the present invention should not be construed as being limited to these Examples. ‘Parts’ described below means ‘parts by weight’, and ‘%’ described below means ‘weight %’ unless otherwise specified.

### (1) Measurement of Number Average Molecular Weight

For the average molecular weight of the resin, the number average molecular weight Mn determined by a GPC method was employed. Specifically, the number average molecular weight of the resin was determined by using a gel permeation chromatographic method (GPC method), and calculating relative to polystyrene samples having known molecular weights. The measurement was made by using a high performance GPC apparatus (manufactured by Tosoh Corp., Japan, trade name: HLC-8020) and a polystyrene-packed column (trade name: TSKgel GMHXL; manufactured by Tosoh Corp., Japan), and developing with tetrahydrofuran (THF). The temperature of the column was set at 40° C. As the sample to be injected into the GPC apparatus, a THF solution having a resin concentration of 1 wt % was prepared, and the injection amount was 10 μl. Furthermore, as the detector, a resin ultraviolet absorption detector was used, and as the monitoring light, light having a wavelength of 254 nm was used.

### (2) Measurement of Average Number of Polymerizable Unsaturated Groups

The average number of polymerizable unsaturated groups present in the molecule of Component A was determined by removing unreacted low molecular weight components using a liquid chromatographic method, and then performing a molecular structure analysis using a nuclear magnetic resonance spectroscopic method (NMR method, manufactured by Bruker Biospin Corp., trade name: “Avance 600”). For example, “1.7-functional” means that the average number of polymerizable unsaturated groups that are present in the molecule is 1.7.

Furthermore, the conversion ratio of the group represented by Formula (I) to the group represented by Formula (II) in Component A is defined as:

Conversion ratio=100−{(Average number of polymerizable unsaturated groups after conversion/average number of polymerizable unsaturated groups before conversion)×100}

Therefore, the ratio of the average numbers of functional groups of the group represented by Formula (I) and the group represented by Formula (II), (I)/(II), is defined as:

Ratio of the average numbers of functional groups (I)/(II)=Average number of polymerizable unsaturated groups after conversion/(average number of polymerizable unsaturated groups before conversion−average number of polymerizable unsaturated groups after conversion).

### (3) Application of Resin Composition on Support

In order to adjust the internal diameter of the cylinder of the printing machine, cushion bridge sleeves (manufactured by AKL Flexo Technik GmbH, Germany, trade name: “OptiFlex-Cushion Bridge”, PU50) having an internal diameter of 152.905 mm, an outer diameter of 175.187 mm, and a width of 1,000 mm were used. The ASKER-C hardness values of the cushion bridge sleeves of PU50 was 78, respectively.

As the support for the resin, a fiber-reinforced plastic sleeve (manufactured by AKL Flexo Technik GmbH, Germany, trade name: “OptiFlex-Basic”) was used. The internal diameter was 175.18 mm, the outer diameter was 175.88 mm, and the width was 1000 mm. A resin composition for laser engraving printing plate precursor was applied on the support with a doctor blade, and was maintained at 130° C. for 60 minutes to cure the resin composition. Thus, a printing plate precursor was obtained. The outermost surface of the printing plate precursor was adjusted by grinding and polishing so that the printing perimeter after curing was 560 mm. The application was regulated with a doctor blade, and thus a laser engraving printing plate precursor for printing evaluation was produced.

### (4) Laser Engraving

As a carbon dioxide laser engraving machine for engraving by laser irradiation, High-grade CO₂ laser marker ML-9100 series (manufactured by KEYENCE CORPORATION) was used. 1 cm square of solid part was raster-engraved under the conditions of output: 12 W, head speed: 200 mm/sec, and pitch setting: 2,400 DPI.

As a semiconductor laser engraving machine, a laser recording apparatus equipped with a fiber-coupled semiconductor laser (FC-LD) SDL-6390 (manufactured by JDS Uniphase Corporation, wavelength: 915 nm) having a maximum output of 8.0 W was used. Using the semiconductor laser engraving machine, 1 cm square of solid part was raster-engraved under the conditions of laser output: 7.5 W, head speed: 409 mm/sec, and pitch setting: 2,400 DPI.

### (5) Evaluation of Relief Printing Plate

Performance of the relief printing plate was evaluated according to items below, and the results are shown in Table 1.

### (5-1) Engraving Depth

“Engraving Depth” of the relief layer which is obtained by laser engraving the relief-forming layer of the relief printing plate precursor was measured as follows. Here, “engraving depth” indicates the difference between the engraved position (height) and the non-engraved position (height) in a case where the cross-section of the relief layer is observed. “Engraving depths” in the present examples were measured by observation using an ultra-depth color 3D profile measurement microscope VK9510 (manufactured by Keyence Corporation). The large engraving depth means a high engraving sensitivity. The results are shown in Table 1.

### (5-2) Rinsing Property

The plate laser-engraved by the CO₂ laser was immersed into alkaline water having a pH of 9.8 and the engraved part was rubbed 10 times with a toothbrush (manufactured by Lion Corporation, clinical toothbrush, flat). Thereafter, whether residue remained in the surface of the relief layer was checked using an optical microscope.

No residue was rated as “excellent”, almost no residue was rated as “good”, a small amount of residue was rated as “fair”, and a case where a residue was not removed was rated as “poor”. The results are shown in Table 1.

### (5-3) Printing Durability

The relief printing plate obtained by laser engraving using the CO₂ laser was set in a printing machine (ITM-4 type, manufactured by IYO KIKAI SEISAKUSHO Co., Ltd.), and printing was continuously performed using an aqueous ink AQUA SPZ 16 RED (manufactured by TOYO INK CO., LTD.) as an ink without dilution and using FULL COLOR FORM M70 (manufactured by Nippon Paper Group, thickness 100 μm) as a printing paper to check a highlight from 1 to 10% on the printed matter. The time when unprinted halftone dots occurred was regarded as completion of printing, and the length (meters) of paper that had been printed until the completion of printing was taken as the index. A larger value of this index was evaluated to have excellent printing durability. The results are shown in Table 1.

### (5-4) Ink Transferability

During the evaluation of printing durability, the degree of adherence of ink at the solid part on a printed matter at a paper length of 500 m and 1,000 m from the initiation of printing were compared by visual inspection.

Evaluation was carried out in 5 grades such that a sample that was uniform without density unevenness was rated as “good”, a sample that had unevenness was rated as “poor, and samples having an intermediate degree between “good” and “poor” were rated as “fairly good”, “fair”, and “fairly poor” in an order closer to “good”. The results are shown in Table 1.

### (5-5) Evaluation of Peeling Resistance

Easy peelability of a film of the relief printing plate precursor was evaluated by a method described below. If the peeling resistance according to the evaluation is high, when an external force is applied to the relief printing plate precursor, peeling from the support or the cushion layer does not occur, and satisfactory handling can be achieved.

The peeling resistance was evaluated as the peeling area determined by a tape peeling test. That is, a coated surface of the relief printing plate precursor was subjected to a checkerboard tape peeling test according to JIS D0202-1988. A cellophane tape (“CT24”, manufactured by Nichiban Co., Ltd.) was used, and the tape was adhered to a film with a finger cushion and then was peeled. The judgment was carried out based on the peeling area ratio (proportion of peeled area with respect to the total film area), such that A: <10%, B: 10 to 30%, and C: >30%. The results are shown in Table 1.

### (Production of Resin Having Group Represented by Formula (I) and Group Represented by Formula (II) in Molecule)

### Production Example 1

In a 1-L separable flask equipped with a thermometer, a stirrer and a circulator, 413.72 g of “KF-6003” (number average molecular weight 5,100, OH value 22.0), which is a both-end type carbinol-modified reactive silicone oil manufactured by Shin-Etsu Chemical Co., Ltd., and 11.05 g of tolylene diisocyanate were added, and the mixture was reacted for about 3 hours under heating at 80° C. Subsequently, 4.99 g of 2-acryloyloxyisocyanate was added thereto, and the mixture was further reacted for about 3 hours to thus produce a resin having acrylic groups at the ends. Furthermore, 0.03 g of Epomine SP-006 (polyethyleneimine, manufactured by Nippon Shokubai Co., Ltd.) was introduced to the resin, and 4.9 g of KBM-803 (3-mercaptopropyltrimethoxysilane, manufactured by Shin-Etsu Chemical Co., Ltd.) was added dropwise thereto while stirring over 30 minutes at room temperature. After the dropwise addition, the mixture was stirred for 2 hours at room temperature, and thus, (A) Resin (A-1) was obtained. The structures of Resin (A-1) and the precursor of (A-1) thus obtained were identified by ¹H-NMR. At this time, the conversion ratio was 70%, the ratio of the average number of functional groups of the group represented by Formula (I) and the group represented by Formula (II), (I)/(II), was 0.42, and the number average molecular weight of Resin (A-1) was 21,000.

### Production Example 2

In a 2-L separable flask equipped with a thermometer, a stirrer and a circulator, 1,318 g of trade name: “PCDL T4672” (number average molecular weight 2,059, OH value 54.5), which is a polycarbonate diol manufactured by Asahi Kasei Chemicals Corp., and 76.8 g of tolylene diisocyanate were added, and the mixture was reacted for about 3 hours under heating at 80° C. Subsequently, 47.8 g of 2-acryloyloxyisocyanate was added thereto, and the mixture was further reacted for about 3 hours to thus produce a resin having acrylic groups at the ends. Furthermore, 0.05 g of triethylamine (manufactured by Wako Pure Chemical Industries, Ltd.) was added to the resin, and 55 g of KBM-803 (3-mercaptopropyltrimethoxysilane, manufactured by Shin-Etsu Chemical Co., Ltd.) was added dropwise thereto while stirring over 30 minutes at room temperature. After the dropwise addition, the mixture was stirred for 2 hours at room temperature, and thus, (A) Resin (A-2) was obtained. The structures of Resin (A-2) and the precursor of (A-2) thus obtained were identified by ¹H-NMR. At this time, the conversion ratio was 80%, the ratio of the average numbers of functional groups of the group represented by Formula (I) and the group represented by Formula (II), (I)/(II), was 0.25, and the number average molecular weight of Resin (A-2) was 11,000.

### Production Example 3

In a 1-L separable flask equipped with a thermometer, a stirrer and a circulator, 396.67 g of “PCDL T4672” (trade name) (number average molecular weight 2,082, OH value 53.9), which is a polycarbonate diol manufactured by Asahi Kasei Chemicals Corp., and 28.4 g of “Duranate TPA-100” (trade name) (number average molecular weight 600, NCO 23%, average number of isocyanate groups fn 3.3), which is a hexamethylene diisocyanate non-yellowing type polyisocyanate manufactured by Asahi Kasei Chemicals Corp., were added, and the mixture was stirred at 80 rpm for about 1 hour under heating at 40° C. Subsequently, 0.2 g of dibutyltin dilaurate as a catalyst was added thereto, and the mixture was reacted for 3 hours. Subsequently, 26.9 g of 2-acryloyloxyisocyanate was added thereto, and the mixture was further reacted for about 3 hours to thus produce a resin having acrylic groups at the ends. Furthermore, 0.14 g of Epomine SP-006 (polyethyleneimine, manufactured by Nippon Shokubai Co., Ltd.) was added, and 26.2 g of KBM-803 (3-mercaptopropyltrimethoxysilane, manufactured by Shin-Etsu Chemical Co., Ltd.) was added dropwise thereto while stirring over 30 minutes at room temperature. After the dropwise addition, the mixture was stirred for 2 hours at room temperature, and thus, (A) Resin (A-3) was obtained. The structures of Resin (A-3) and the precursor of (A-3) thus obtained were identified by ¹H-NMR. At this time, the conversion ratio was 70%, the ratio of the average number of functional groups of the group represented by Formula (I) and the group represented by Formula (II), (I)/(II), was 0.42, and the number average molecular weight of Resin (A-3) was 9,500.

### Production Example 4

In a 500-ml separable flask equipped with a thermometer, a stirrer and a circulator, 160.01 g of 1-methoxy-2-propanol was introduced and was heated up to 70° C. under a nitrogen gas stream. A solution of 94.10 g of diethylene glycol monomethyl ether, 43.10 g of methacrylic acid, and 1.84 g of V-601 in 160.01 g of 1-methoxy-2-propanol was added dropwise thereto over 2.5 hours. After the dropwise addition, the mixture was heated to 90° C., and was further stirred for 2 hours. The reaction solution was cooled to room temperature, and then 80 g of glycidyl methacrylate, 0.43 g of p-methoxyphenol, and 2.17 g of tetraethylammonium bromide were added to the reaction solution. The mixture was heated again to 90° C., and was stirred for 8 hours to thus produce a resin containing methacrylic groups in side chain. Furthermore, 0.31 g of DBU (diazabicycloundecene) was added thereto, and 58.9 g of KBM-803 (3-mercaptopropyltrimethoxysilane, manufactured by Shin-Etsu Chemical Co., Ltd.) was added dropwise thereto while stirring over 30 minutes at room temperature. After the dropwise addition, the mixture was stirred for 5 hours at room temperature, and thus, (A) Resin (A-4) was obtained (1-methoxy-2-propanol solution). The structures of Resin (A-4) and the precursor of (A-4) thus obtained were identified by ¹H-NMR. At this time, the conversion ratio was 60%, the ratio of the average number of functional groups of the group represented by Formula (I) and the group represented by Formula (II), (I)/(II), was 0.66, and the number average molecular weight of Resin (A-4) was 26,000.

### Production Example 5

In a 500-ml separable flask equipped with a thermometer, a stirrer and a circulator, 26.0 g (0.10 moles) of following Diol Compound (1) was dissolved in 100 ml of N,N-dimethylacetamide. To this, 25.5 g (0.102 moles) of 4,4-diphenylmethane diisocyanate, and 0.1 g of dibutyltin dilaurate were added, and the mixture was heated and stirred at 100° C. for 8 hours. Thereafter, the reaction mixture was diluted with 100 ml of N,N-dimethylformamide and 200 ml of methyl alcohol, and the dilution was stirred for 30 minutes. Furthermore, 0.05 g of DBU (diazabicycloundecene) was added thereto, and 13.7 g of KBM-803 (3-mercaptopropyltrimethoxysilane, manufactured by Shin-Etsu Chemical Co., Ltd.) was added dropwise thereto while stirring over 30 minutes at room temperature. After the dropwise addition, the mixture was stirred for 5 hours at room temperature, reprecipitated with water, dried, and then was dissolved in 80 g of MEK (methyl ethyl ketone). Thus, (A) Resin (A-5) (MEK solution) was obtained. The structures of Resin (A-5) and the precursor of (A-5) thus obtained were identified by ¹H-NMR. At this time, the conversion ratio was 70%, the ratio of the average number of functional groups of the group represented by Formula (I) and the group represented by Formula (II), (I)/(II), was 0.42, and the number average molecular weight of Resin (A-5) was 36,000.

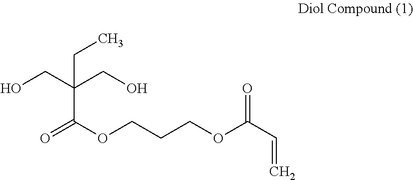

### Production Example 6

In a 1-L separable flask equipped with a thermometer, a stirrer and a circulator, 396.67 g of “PCDL T4672” (trade name) (number average molecular weight 2,082, OH value 53.9), which is a polycarbonate diol manufactured by Asahi Kasei Chemicals Corp., and 28.4 g of “Duranate TPA-100” (trade name) (number average molecular weight 600, NCO 23%, average number of isocyanate groups fn 3.3), which is a hexamethylene diisocyanate non-yellowing type polyisocyanate manufactured by Asahi Kasei Chemicals Corp. were added, and the mixture was stirred at 80 rpm for about 1 hour under heating at 40° C. Subsequently, 0.2 g of dibutyltin dilaurate as a catalyst was added thereto, and the mixture was reacted for 3 hours. Subsequently, 26.9 g of 2-acryloyloxyisocyanate was added thereto, and the mixture was further reacted for about 3 hours to thus produce a resin having acrylic groups at the ends. Furthermore, 0.1 g of Epomine SP-006 (polyethyleneimine, manufactured by Nippon Shokubai Co., Ltd.) was added, and 16.8 g of KBM-803 (3-mercaptopropyltrimethoxysilane, manufactured by Shin-Etsu Chemical Co., Ltd.) was added dropwise thereto while stirring over 30 minutes at room temperature. After the dropwise addition, the mixture was stirred for 2 hours at room temperature, and thus, (A) Resin (A-6) was obtained. The structures of Resin (A-6) and the precursor of (A-6) thus obtained were identified by ¹H-NMR. At this time, the conversion ratio was 45%, the ratio of the average number of functional groups of the group represented by Formula (I) and the group represented by Formula (II), (I)/(II), was 1.2, and the number average molecular weight of Resin (A-6) was 10,000.

### Production Example 7

In a 1-L separable flask equipped with a thermometer, a stirrer and a circulator, 396.67 g of “PCDL T4672” (trade name) (number average molecular weight 2,082, OH value 53.9), which is a polycarbonate diol manufactured by Asahi Kasei Chemicals Corp., and 28.4 g of “Duranate TPA-100” (trade name) (number average molecular weight 600, NCO 23%, average number of isocyanate groups fn 3.3), which is a hexamethylene diisocyanate non-yellowing type polyisocyanate manufactured by Asahi Kasei Chemicals Corp. were added, and the mixture was stirred at 80 rpm for about 1 hour under heating at 40° C. Subsequently, 0.2 g of dibutyltin dilaurate as a catalyst was added thereto, and the mixture was reacted for 3 hours. Subsequently, 26.9 g of 2-acryloyloxyisocyanate was added thereto, and the mixture was further reacted for about 3 hours to thus produce a resin having acrylic groups at the ends. Furthermore, 0.07 g of Epomine SP-006 (polyethyleneimine, manufactured by Nippon Shokubai Co., Ltd.) was introduced to the resin, and 11.2 g of KBM-803 (3-mercaptopropyltrimethoxysilane, manufactured by Shin-Etsu Chemical Co., Ltd.) was added dropwise thereto while stirring over 30 minutes at room temperature. After the dropwise addition, the mixture was stirred for 2 hours at room temperature, and thus, (A) Resin (A-7) was obtained. The structures of Resin (A-7) and the precursor of (A-7) thus obtained were identified by ¹H-NMR. At this time, the conversion ratio was 30%, the ratio of the average number of functional groups of the group represented by Formula (I) and the group represented by Formula (II), (I)/(II), was 2.3, and the number average molecular weight of Resin (A-7) was 9,000.

### Production Example 8

In a 500-ml separable flask equipped with a thermometer, a stirrer and a circulator, 160.01 g of 1-methoxy-2-propanol was introduced, and was heated to 70° C. under a nitrogen gas stream. A solution of 94.10 g of diethylene glycol monomethyl ether, 43.10 g of methacrylic acid, and 1.84 g of V-601 in 160.01 g of 1-methoxy-2-propanol was added dropwise thereto over 2.5 hours. After the dropwise addition, the mixture was heated to 90° C., and was further stirred for 2 hours. The reaction solution was cooled to room temperature, and then 40 g of glycidyl methacrylate, 0.22 g of p-methoxyphenol, and 1.09 g of tetraethylammonium bromide were added thereto. The mixture was heated again to 90° C., and was stirred for 8 hours to thus produce a resin containing methacrylic groups in side chains. Furthermore, 0.16 g of DBU (diazabicycloundecene) was added, and 29.5 g of KBM-803 (3-mercaptopropyltrimethoxysilane, manufactured by Shin-Etsu Chemical Co., Ltd.) was added dropwise thereto while stirring over 30 minutes at room temperature. After the dropwise addition, the mixture was stirred for 5 hours at room temperature, and thus, (A) Resin (A-8) was obtained (1-methoxy-2-propanol solution). The structures of Resin (A-8) and the precursor of (A-8) thus obtained were identified by ¹H-NMR. At this time, the conversion ratio was 60%, the ratio of the average number of functional groups of the group represented by Formula (I) and the group represented by Formula (II), (I)/(II), was 0.66, and the number average molecular weight of Resin (A-8) was 30,000.

### Production Example 9

In a 500-ml separable flask equipped with a thermometer, a stirrer and a circulator, 8.2 g (0.05 moles) of 2,2-bis(hydroxymethyl)butanoic acid, and 13.0 g (0.05 moles) of Diol Compound (1) described above were dissolved in 100 ml of N,N-dimethylacetamide. To this, 25.5 g (0.102 moles) of 4,4-diphenylmethane diisocyanate, and 0.1 g of dibutyltin dilaurate were added, and the mixture was heated and stirred for 8 hours at 100° C. Thereafter, the reaction mixture was diluted with 100 ml of N,N-dimethylformamide and 200 ml of methyl alcohol, and the dilution was stirred for 30 minutes. Furthermore, 0.03 g of DBU (diazabicycloundecene) was added thereto, and 6.9 g of KBM-803 (3-mercaptopropyltrimethoxysilane, manufactured by Shin-Etsu Chemical Co., Ltd.) was added dropwise thereto while stirring over 30 minutes at room temperature. After the dropwise addition, the mixture was stirred for 5 hours, reprecipitated with water, dried, and then was dissolved in 66 g of MEK. Thus, (A) Resin (A-9) (MEK solution) was obtained. The solution was reprecipitated with water, and thus (A) Resin (A-9) was obtained. The structures of Resin (A-9) and the precursor of (A-9) thus obtained were identified by ¹H-NMR. At this time, the conversion ratio was 72%, the ratio of the average number of functional groups of the group represented by Formula (I) and the group represented by Formula (II), (I)/(II), was 0.38, and the number average molecular weight of Resin (A-9) was 33,000.

### Production Example 10

In a 1-L separable flask equipped with a thermometer, a stirrer and a circulator, 413.72 g of “KF-6003” (number average molecular weight 5,100, OH value 22.0), which is a both-end type carbinol-modified reactive silicone oil manufactured by Shin-Etsu Chemical Co., Ltd., and 11.05 g of tolylene diisocyanate were added, and the mixture was reacted for about 3 hours under heating at 80° C. Subsequently, 4.99 g of 2-acryloyloxyisocyanate was added thereto, and the mixture was further reacted for about 3 hours to thus produce a resin having acrylic groups at the ends. Furthermore, 0.06 g of DBU (diazabicycloundecene) was added thereto, and 4.5 g of KBM-903 (3-aminopropyltrimethoxysilane, manufactured by Shin-Etsu Chemical Co., Ltd.) was added dropwise thereto while stirring over 30 minutes at room temperature. After the dropwise addition, the mixture was stirred for 4 hours at 70° C., and thus, (A) Resin (A-10) was obtained. The structures of Resin (A-10) and the precursor of (A-10) thus obtained were identified by ¹H-NMR. At this time, the conversion ratio was 70%, the ratio of the average number of functional groups of the group represented by Formula (I) and the group represented by Formula (II), (I)/(11), was 0.42, and the number average molecular weight of Resin (A-10) was 20,000.

### Production Example 11

In a 500-ml separable flask equipped with a thermometer, a stirrer and a circulator, 100.0 g (0.05 moles) of polypropylene glycol (average molecular weight 2,000) was dissolved in 300 ml of N,N-dimethylacetamide. To this, 9.6 g (0.055 moles) of 4,4-diphenylmethane diisocyanate, and 0.2 g of dibutyltin dilaurate were added, and the mixture was heated and stirred for 8 hours at 100° C. Thereafter, the reaction mixture was diluted with 300 ml of N,N-dimethylformamide and 600 ml of methyl alcohol, and the dilution was stirred for 30 minutes. This was reprecipitated with water, dried, and dissolved in 134 g of MEK, and thus Comparative Resin (AC-1) (MEK solution) was obtained. The number average molecular weight of Resin (AC-1) was 31,000.

### Production Example 12

In a 1-L separable flask equipped with a thermometer, a stirrer and a circulator, 413.72 g of “KF-6003” (number average molecular weight 5,100, OH value 22.0), which is a both-end type carbinol-modified reactive silicone oil manufactured by Shin-Etsu Chemical Co., Ltd., and 11.05 g of tolylene diisocyanate were added, and the mixture was reacted for about 3 hours under heating at 80° C. Subsequently, 4.99 g of 2-acryloyloxyisocyanate was added thereto, and the mixture was further reacted for about 3 hours. Thus, Resin (AC-2), which was a comparative resin having acrylic groups at the ends, was obtained. The number average molecular weight of Resin (AC-2) was 19,000.

### Production Example 13

In a 2-L separable flask equipped with a thermometer, a stirrer and a circulator, 1,318 g of trade name: “PCDL T4672” (number average molecular weight 2,059, OH value 54.5), which is a polycarbonate diol manufactured by Asahi Kasei Chemicals Corp., and 76.8 g of tolylene diisocyanate were added, and the mixture was reacted for about 3 hours under heating at 80° C. Subsequently, 47.8 g of 2-acryloyloxyisocyanate was added thereto, and the mixture was further reacted for about 3 hours. Thus, Resin (AC-3), which was a comparative resin having acrylic groups at the ends, was obtained. The number average molecular weight of Resin (AC-3) was 10,000.

### Production Example 14

In a 500-ml separable flask equipped with a thermometer, a stirrer and a circulator, 130 g of 1-methoxy-2-propanol was introduced, and was heated to 70° C. under a nitrogen gas stream. A solution of 94.10 g of diethylene glycol monomethyl ether, 124.3 g of KBM-503 (3-methacryloxypropyltriethoxysilane, manufactured by Shin-Etsu Chemical Co., Ltd.), and 1.84 g of V-601 in 130 g of 1-methoxy-2-propanol was added dropwise thereto over 2.5 hours. After the dropwise addition, the mixture was heated to 80° C., and was further stirred for 2 hours. Thus, Resin (AC-4) containing alkoxysilyl groups in side chains was produced (1-methoxy-2-propanol solution). The number average molecular weight of Resin (AC-4) was 56,000.

### Example 1

| Component A: A-1 | 100 | parts |
|---|---|---|
| Component B: trade name: “Sylosphere C-1504” | 15.4 | parts |
| (manufactured by Fuji Silysia Chemical, Ltd., number | | |
| average particle size 4.5 μm, specific surface area | | |
| 520 m²/g, average fine pore diameter 12 nm, fine | | |
| pore volume 1.5 ml/g, loss on ignition 2.5 wt %, | | |
| oil absorption 290 ml/100 g, the true sphericity | | |
| of added Sylosphere C-1504, which is a porous | | |
| spherical silica, was observed using a scanning | | |
| electron microscope, and almost all the particles | | |
| were 0.9 or higher.) | | |
| Component C: DBU (diazabicycloundecene) | 0.5 | parts |
| Component D: PBE | 0.5 | parts |

(t-butylperoxy-2-ethylhexyl carbonate (manufactured
by NOF Corp., trade name: “Perbutyl E”))

The above components were added and were stirred for 30 minutes at 25° C. to thus prepare a liquid resin composition. Subsequently, the resin composition was molded on a support by the method described above, and thus, a relief printing plate precursor for laser engraving was produced. This was subjected to laser engraving.

The results obtained by performing the respective evaluations by the methods described above are shown in Table 1.

### Example 2

| Component A: A-1 | 100 | parts |
|---|---|---|
| Component B: trade name: “Sylosphere C-1504” | 15.4 | parts |
| (manufactured by Fuji Silysia Chemical, Ltd., number | | |
| average particle size 4.5 μm, specific surface area | | |
| 520 m²/g, average fine pore diameter 12 nm, fine | | |
| pore volume 1.5 ml/g, loss on ignition 2.5 wt %, | | |
| oil absorption 290 ml/100 g, the true sphericity | | |
| of added Sylosphere C-1504, which is a porous | | |
| spherical silica, was observed using a scanning | | |
| electron microscope, and almost all the particles | | |
| were 0.9 or higher.) | | |
| Component C: DBU (diazabicycloundecene) | 0.5 | parts |
| Component D: PBE | 0.5 | parts |
| (t-butylperoxy-2-ethylhexyl carbonate (manufactured | | |
| by NOF Corp., trade name: “Perbutyl E”)) | | |
| Component G: Ketjen Black EC600JD | 10 | parts |

(carbon black, manufactured by Lion Corp.,
indicated as CB-1 in Table 1)

The above components were added and were stirred for 30 minutes at 25° C. to thus prepare a liquid resin composition. Subsequently, the resin composition was molded on a support by the method described above, and thus, a relief printing plate precursor for laser engraving was produced. This was subjected to laser engraving.

The results obtained by performing the respective evaluations by the methods described above are shown in Table 1.

### Example 3

| Component A: A-1 | 100 | parts |
|---|---|---|
| Component B: trade name: “Sylosphere C-1504” | 15.4 | parts |
| (manufactured by Fuji Silysia Chemical, Ltd., number | | |
| average particle size 4.5 μm, specific surface area | | |
| 520 m²/g, average fine pore diameter 12 nm, fine | | |
| pore volume 1.5 ml/g, loss on ignition 2.5 wt %, | | |
| oil absorption 290 ml/100 g, the true sphericity | | |
| of added Sylosphere C-1504, which is a porous | | |
| spherical silica, was observed using a scanning | | |
| electron microscope, and almost all the particles | | |
| were 0.9 or higher.) | | |
| Component C: DBU (diazabicycloundecene) | 0.5 | parts |
| Component D: PBE | 0.5 | parts |
| (t-butylperoxy-2-ethylhexyl carbonate (manufactured | | |
| by NOF Corp., tradename: “Perbutyl E”)) | | |
| Component E: E-1 described below | 30 | parts |
| Component G: Ketjen Black EC600JD | 10 | parts |

(carbon black, manufactured by Lion Corp.)

The above components were added and were stirred for 30 minutes at 25° C. to thus prepare a liquid resin composition. Subsequently, the resin composition was molded on a support by the method described above, and thus, a relief printing plate precursor for laser engraving was produced. This was subjected to laser engraving.

The results obtained by performing the respective evaluations by the methods described above are shown in Table 1.

### Example 4

| | | |
|---|---|---|
| Component A: A-1 | 100 | parts |
| Component B: trade name: “Sylosphere C-1504” | 15.4 | parts |
| (manufactured by Fuji Silysia Chemical, Ltd., number | | |
| average particle size 4.5 μm, specific surface area | | |
| 520 m²/g, average fine pore diameter 12 nm, fine | | |
| pore volume 1.5 ml/g, loss on ignition 2.5 wt %, | | |
| oil absorption 290 ml/100 g, the added true sphericity | | |
| of Sylosphere C-1504, which is a porous spherical | | |
| silica, was observed using a scanning electron | | |
| microscope, and almost all the particles were 0.9 | | |
| or higher.) | | |
| Component C: DBU (diazabicycloundecene) | 0.5 | parts |
| Component D: PBE | 0.5 | parts |
| (t-butylperoxy-2-ethylhexyl carbonate (manufactured | | |
| by NOF Corp., trade name: “Perbutyl E”)) | | |
| Component F: F-1 described below | 70 | parts |
| Component G: Ketjen Black EC600JD | 10 | parts |
| (carbon black, manufactured by Lion Corp.) | | |

The above components were added and were stirred for 30 minutes at 25° C. to thus prepare a liquid resin composition. Subsequently, the resin composition was molded on a support by the method described above, and thus, a relief printing plate precursor for laser engraving was produced. This was subjected to laser engraving.

The results obtained by performing the respective evaluations by the methods described above are shown in Table 1.

### Example 5

| | | |
|---|---|---|
| Component A: A-1 | 100 | parts |
| Component B: trade name: “Sylosphere C-1504” | 15.4 | parts |
| (manufactured by Fuji Silysia Chemical, Ltd., number | | |
| average particle size 4.5 μm, specific surface area | | |
| 520 m²/g, average fine pore diameter 12 nm, fine | | |
| pore volume 1.5 ml/g, loss on ignition 2.5 wt %, | | |
| oil absorption 290 ml/100 g, the true sphericity | | |
| of added Sylosphere C-1504, which is a porous | | |
| spherical silica, was observed using a scanning | | |
| electron microscope, and almost all the particles | | |
| were 0.9 or higher.) | | |
| Component C: DBU (diazabicycloundecene) | 0.5 | parts |
| Component D: PBE | 0.5 | parts |
| (t-butylperoxy-2-ethylhexyl carbonate (manufactured | | |
| by NOF Corp., trade name: “Perbutyl E”)) | | |
| Component E: E-1 described below | 30 | parts |
| Component F: F-1 described below | 70 | parts |
| Component G: Ketjen Black EC600JD | 10 | parts |
| (carbon black, manufactured by Lion Corp.) | | |

The above components were added and were stirred for 30 minutes at 25° C. to thus prepare a liquid resin composition. Subsequently, the resin composition was molded on a support by the method described above, and thus, a relief printing plate precursor for laser engraving was produced. This was subjected to laser engraving.

The results obtained by performing the respective evaluations by the methods described above are shown in Table 1.

### Example 6

A relief printing plate precursor for laser engraving was produced in the same manner as in Example 5, except that 100 parts of A-2 was used as Component A, and this was subjected to laser engraving.

The results obtained by performing the respective evaluations by the methods described above are shown in Table 1.

### Example 7

A relief printing plate precursor for laser engraving was produced in the same manner as in Example 5, except that 100 parts of A-3 was used as Component A, and this was subjected to laser engraving.

The results obtained by performing the respective evaluations by the methods described above are shown in Table 1.

### Example 8

A relief printing plate precursor for laser engraving was produced in the same manner as in Example 5, except that 220 parts of A-4 (1-methoxy-2-propanol solution) was used as Component A, and this was subjected to laser engraving.

The results obtained by performing the respective evaluations by the methods described above are shown in Table 1.

### Example 9

A relief printing plate precursor for laser engraving was produced in the same manner as in Example 5, except that 220 parts of A-5 (MEK solution) was used as Component A, and this was subjected to laser engraving.

The results obtained by performing the respective evaluations by the methods described above are shown in Table 1.

### Example 10

A relief printing plate precursor for laser engraving was produced in the same manner as in Example 5, except that 100 parts of A-6 was used as Component A, and this was subjected to laser engraving.

The results obtained by performing the respective evaluations by the methods described above are shown in Table 1.

### Example 11

A relief printing plate precursor for laser engraving was produced in the same manner as in Example 5, except that 100 parts of A-7 was used as Component A, and this was subjected to laser engraving.

The results obtained by performing the respective evaluations by the methods described above are shown in Table 1.

### Example 12

A relief printing plate precursor for laser engraving was produced in the same manner as in Example 5, except that 220 parts of A-8 (1-methoxy-2-propanol solution) was used as Component A, and this was subjected to laser engraving.

The results obtained by performing the respective evaluations by the methods described above are shown in Table 1.

### Example 13

A relief printing plate precursor for laser engraving was produced in the same manner as in Example 5, except that 220 parts of A-9 (MEK solution) was used as Component A, and this was subjected to laser engraving.

The results obtained by performing the respective evaluations by the methods described above are shown in Table 1.

### Example 14

A relief printing plate precursor for laser engraving was produced in the same manner as in Example 5, except that 100 parts of A-10 was used as Component A, and this was subjected to laser engraving.

The results obtained by performing the respective evaluations by the methods described above are shown in Table 1.

### Comparative Example 1

A relief printing plate precursor for laser engraving was produced in the same manner as in Example 5, except that 220 parts of AC-1 (MEK solution) was used instead of Component A, and this was subjected to laser engraving.

The results obtained by performing the respective evaluations by the methods described above are shown in Table 1.

### Comparative Example 2

A relief printing plate precursor for laser engraving was produced in the same manner as in Example 5, except that 100 parts of AC-2 was used instead of Component A, and this was subjected to laser engraving.

The results obtained by performing the respective evaluations by the methods described above are shown in Table 1.

### Comparative Example 3

A relief printing plate precursor for laser engraving was produced in the same manner as in Example 5, except that 100 parts of AC-3 was used instead of Component A, and this was subjected to laser engraving.

The results obtained by performing the respective evaluations by the methods described above are shown in Table 1.

### Comparative Example 4

A relief printing plate precursor for laser engraving was produced in the same manner as in Example 5, except that 220 parts of AC-4 (1-methoxy-2-propanol solution) was used instead of Component A, and this was subjected to laser engraving.

The results obtained by performing the respective evaluations by the methods described above are shown in Table 1.

### Comparative Example 5

A relief printing plate precursor for laser engraving was produced in the same manner as in Example 5, except that 50 parts of AC-2 and 110 parts of AC-4 (1-methoxy-2-propanol solution) was used instead of Component A, and this was subjected to laser engraving.

The results obtained by performing the respective evaluations by the methods described above are shown in Table 1.

TABLE 1

| | |
|---|---|
| | (E-1) |
| 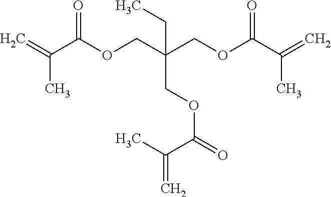 | |
| | (F-1) |
| 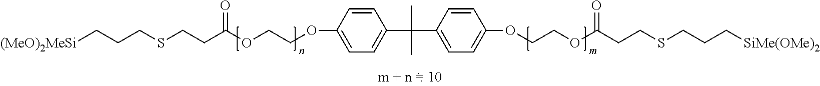 | |

| | | | | | | Performance evaluation | | | | | |
|---|---|---|---|---|---|---|---|---|---|---|---|
| | | | | | | Engraving depth | | | | | |
| | Binder | | | | | (μm) | | | Printing | | |
| | (A) | | | | | | CO₂ | Rinsing | durability | Ink | Peeling |
| | Type | (I)/(II) | (E) | (F) | (G) | FC-LD | laser | property | (m) | transferability | resistance |
| Example 1 | A-1 | 0.42 | None | None | None | 1 | 280 | Fair | 1,200 | Fair | Good |
| Example 2 | A-1 | 0.42 | None | None | CB-1 | 380 | 300 | Fair | 1,450 | Fair | Good |
| Example 3 | A-1 | 0.42 | E-1 | None | CB-1 | 370 | 290 | Fair | 1,600 | Fair | Good |
| Example 4 | A-1 | 0.42 | None | F-1 | CB-1 | 365 | 270 | Good | 1,700 | Good | Good |
| Example 5 | A-1 | 0.42 | E-1 | F-1 | CB-1 | 390 | 290 | Good | 2,150 | Good | Good |
| Example 6 | A-2 | 0.25 | E-1 | F-1 | CB-1 | 400 | 300 | Good | 1,600 | Good | Good |
| Example 7 | A-3 | 0.42 | E-1 | F-1 | CB-1 | 405 | 300 | Good | 2,000 | Good | Good |
| Example 8 | A-4 | 0.66 | E-1 | F-1 | CB-1 | 395 | 295 | Good | 2,250 | Fairly good | Good |
| Example 9 | A-5 | 0.42 | E-1 | F-1 | CB-1 | 410 | 310 | Good | 2,300 | Good | Good |
| Example 10 | A-6 | 1.2 | E-1 | F-1 | CB-1 | 390 | 290 | Good | 1,800 | Fairly good | Good |
| Example 11 | A-7 | 2.3 | E-1 | F-1 | CB-1 | 385 | 280 | Good | 1,650 | Fairly good | Good |
| Example 12 | A-8 | 0.66 | E-1 | F-1 | CB-1 | 405 | 295 | Excellent | 2,400 | Fairly good | Good |
| Example 13 | A-9 | 0.38 | E-1 | F-1 | CB-1 | 390 | 290 | Good | 1,850 | Fairly good | Good |
| Example 14 | A-10 | 0.42 | E-1 | F-1 | CB-1 | 380 | 270 | Good | 2,000 | Fairly good | Good |
| Comparative | AC-1 | — | E-1 | F-1 | CB-1 | 170 | 120 | Poor | 500 | Fairly poor | Poor |
| Example 1 | | | | | | | | | | | |
| Comparative | AC-2 | — | E-1 | F-1 | CB-1 | 160 | 100 | Poor | 650 | Poor | Poor |
| Example 2 | | | | | | | | | | | |
| Comparative | AC-3 | — | E-1 | F-1 | CB-1 | 170 | 110 | Poor | 680 | Poor | Poor |
| Example 3 | | | | | | | | | | | |
| Comparative | AC-4 | — | E-1 | F-1 | CB-1 | 210 | 170 | Fair | 550 | Fair | Fair |
| Example 4 | | | | | | | | | | | |
| Comparative | AC-2 | — | E-1 | F-1 | CB-1 | 190 | 150 | Fair | 1,500 | Fairly poor | Poor |
| Example 5 | AC-4 | | | | | | | | | | |

From the results given above, it can be seen that according to the present invention, a laser engraved printing plate having excellent laser engraving sensitivity (engraving depth), rinsing property, ink transferability, printing durability, and peeling resistance is obtained. Furthermore, it was understood that a polymer containing a carboxylic acid, a radical and an alkoxysilane crosslinkable group, which was obtained by the method, is good in other performance as well as in the rinsing property.

What is claimed is:

1. A resin composition for laser engraving, comprising (Component A) a resin having a group represented by following Formula (I) and a group represented by following Formula (II), and having a number average molecular weight of 5,000 or more and 500,000 or less: 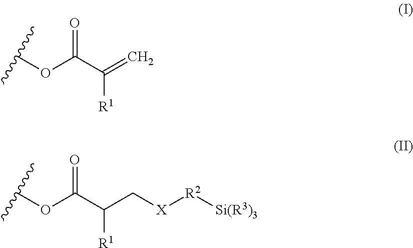
wherein, X represents —S— or —N(R⁰; R⁰ represents a hydrogen atom or an alkyl group; R¹ represents a hydrogen atom or a methyl group; R² represents a divalent linking group; and R³s each independently represent an alkoxy group, a halogen atom, or an alkyl group having 1 to 30 carbon atoms, however, at least one of R³s is an alkoxy group or a halogen atom.

2. The resin composition for laser engraving according to claim 1, wherein the ratio of the average numbers of functional groups of the group represented by Formula (I) and the group represented by Formula (II) ((I)/(II)) in Component A is 0.1 or more and 4 or less.

3. The resin composition for laser engraving according to claim 1, wherein the ratio of the average numbers of functional groups of the group represented by Formula (I) and the group represented by Formula (II) ((I)/(II)) in Component A is 0.3 or more and 1.5 or less.

4. The resin composition for laser engraving according to claim 1, wherein the ratio of the average numbers of functional groups of the group represented by Formula (I) and the group represented by Formula (II) ((I)/(II)) in Component A is 0.4 or more and 1.0 or less.

5. The resin composition for laser engraving according to claim 1, wherein Component A is at least one resin selected from the group consisting of a carbonate resin, a urethane resin, an acrylic resin and an ester resin.

6. The resin composition for laser engraving according to claim 1, further comprising (Component B) silica particles.

7. The resin composition for laser engraving according to claim 6, wherein the number average particle size of Component B is 0.01 μm or more and 10 μm or less.

8. The resin composition for laser engraving according to claim 1, further comprising (Component C) an alcohol exchange reaction catalyst.

9. The resin composition for laser engraving according to claim 1, further comprising (Component D) a radical polymerization initiator.

10. The resin composition for laser engraving according to claim 1, further comprising (Component E) a compound having a weight average molecular weight of less than 5,000 and having a polymerizable unsaturated group.

11. The resin composition for laser engraving according to claim 1, further comprising (Component F) a compound having a weight average molecular weight of less than 5,000 and having a hydrolyzable silyl group and/or silanol group.

12. The resin composition for laser engraving according to claim 1, further comprising (Component G) a photothermal conversion agent capable of absorbing light having a wavelength of 700 to 1,300 nm.

13. A relief printing plate precursor for laser engraving, comprising a relief-forming layer formed from the resin composition for laser engraving according to claim 1 on a support.

14. The relief printing plate precursor for laser engraving according to claim 13, wherein the relief-forming layer is crosslinked by light and/or heat.

15. The relief printing plate precursor for laser engraving according to claim 13, wherein the relief-forming layer is crosslinked by heat.

16. A process for making a relief printing plate, comprising:
(1) a step of forming a layer of the resin composition for laser engraving from the resin composition for laser engraving according to claim 1;
(2) a step of crosslinking the layer of the resin composition for laser engraving by light and/or heat to thus form a crosslinked relief-forming layer; and
(3) a step of laser-engraving the crosslinked relief-forming layer to form a relief layer,
in this order.

17. The process for making a relief printing plate according to claim 16, wherein Step (2) is a step of crosslinking the relief-forming layer by heat.

18. A relief printing plate comprising a relief layer which is manufactured by the process according to claim 16.

19. The relief printing plate according to claim 18, wherein the thickness of the relief layer is 0.05 mm or more and 10 mm or less.
